(19) United States
(12) Patent Application Publication
(10) Pub. No.: US 2024/0020885 A1
(43) Pub. Date: Jan. 18, 2024

(54) POINT CLOUD DATA TRANSMISSION METHOD, POINT CLOUD DATA TRANSMISSION DEVICE, POINT CLOUD DATA RECEPTION METHOD, AND POINT CLOUD DATA RECEPTION DEVICE

(71) Applicant: LG ELECTRONICS INC., Seoul (KR)

(72) Inventors: Sooyeon LEE, Seoul (KR); Hansol CHOI, Seoul (KR); Donggyu SIM, Seoul (KR); Sejin OH, Seoul (KR)

(21) Appl. No.: 18/036,644

(22) PCT Filed: Nov. 23, 2021
(86) PCT No.: PCT/KR2021/017215

§ 371 Date: May 11, 2023

(30) Foreign Application Priority Data
Dec. 3, 2020 (KR) 10-2020-0167567

(51) Int. Cl. G06T 9/00; G06T 7/60; H04N 19/597

(52) U.S. Cl. CPC G06T 9/001; G06T 7/60; H04N 19/597

(57) ABSTRACT

A point cloud data transmission method according to embodiments may comprise the steps of: encoding point cloud data; and transmitting a bitstream including the point cloud data. Furthermore, a point cloud data transmission device according to embodiments may comprise: an encoder which encodes point cloud data; and a transmitter which transmits a bitstream including the point cloud data. Furthermore, a point cloud data reception method according to embodiments may comprise the steps of: receiving a bitstream including point cloud data; and decoding the point cloud data. Furthermore, a point cloud data reception device according to embodiments may comprise: a receiver which receives a bitstream including point cloud data; and a decoder which decodes the point cloud data.

### TECHNICAL FIELD

Embodiments relate to a method and device for processing point cloud content.

### BACKGROUND

Point cloud content is content represented by a point cloud, which is a set of points belonging to a coordinate system representing a three-dimensional space. The point cloud content may express media configured in three dimensions, and is used to provide various services such as virtual reality (VR), augmented reality (AR), mixed reality (MR), and self-driving services. However, tens of thousands to hundreds of thousands of point data are required to represent point cloud content. Therefore, there is a need for a method for efficiently processing a large amount of point data.

### SUMMARY

Embodiments provide a device and method for efficiently processing point cloud data. Embodiments provide a point cloud data processing method and device for addressing latency and encoding/decoding complexity.

The technical scope of the embodiments is not limited to the aforementioned technical objects, and may be extended to other technical objects that may be inferred by those skilled in the art based on the entire contents disclosed herein.

To achieve these objects and other advantages and in accordance with the purpose of the disclosure, as embodied and broadly described herein, a method of transmitting point cloud data may include encoding the point cloud data, and transmitting a bitstream containing the point cloud data. A method of receiving point cloud data according to embodiments may include receiving a bitstream containing point cloud data and decoding the point cloud data.

Devices and methods according to embodiments may process point cloud data with high efficiency.

The devices and methods according to the embodiments may provide a high-quality point cloud service.

The devices and methods according to the embodiments may provide point cloud content for providing general-purpose services such as a VR service and a self-driving service.

### DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. For a better understanding of various embodiments described below, reference should be made to the description of the following embodiments in connection with the accompanying drawings. The same reference numbers will be used throughout the drawings to refer to the same or like parts. In the drawings:

FIG. 1 shows an exemplary point cloud content providing system according to embodiments;

FIG. 2 is a block diagram illustrating a point cloud content providing operation according to embodiments;

FIG. 3 illustrates an exemplary process of capturing a point cloud video according to embodiments;

FIG. 4 illustrates an exemplary point cloud encoder according to embodiments;

FIG. 5 shows an example of voxels according to embodiments;

FIG. 6 shows an example of an octree and occupancy code according to embodiments;

FIG. 7 shows an example of a neighbor node pattern according to embodiments;

FIG. 8 illustrates an example of point configuration in each LOD according to embodiments;

FIG. 9 illustrates an example of point configuration in each LOD according to embodiments;

FIG. 10 illustrates a point cloud decoder according to embodiments;

FIG. 11 illustrates a point cloud decoder according to embodiments;

FIG. 12 illustrates a transmission device according to embodiments;

FIG. 13 illustrates a reception device according to embodiments;

FIG. 14 illustrates an exemplary structure operable in connection with point cloud data transmission/reception methods/devices according to embodiments;

FIG. 15 is a block diagram illustrating an example of a point cloud encoder according to embodiments;

FIG. 16 is a block diagram illustrating an example of a point cloud decoder according to embodiments;

FIG. 17 illustrates a process of generating residual geometry information of a point cloud data transmission device according to embodiments;

FIG. 18 illustrates a process of selecting geometry information of a point cloud data transmission device according to embodiments;

FIG. 19 illustrates a process of generating residual geometry information of a point cloud data transmission device according to embodiments;

FIG. 20 illustrates a process of generating residual geometry information of a point cloud data transmission device according to embodiments;

FIG. 21 shows an example of a process of transforming or quantizing residual geometry information of a point cloud data transmission device according to embodiments;

FIG. 22 illustrates an operation of a transformation unit and transformation method selection module according to embodiments;

FIG. 23 shows an example of transforming residual geometry information of a point cloud data transmission device according to embodiments;

FIG. 24 shows an example of a quantization process of a point cloud data transmission device according to embodiments;

FIG. 25 illustrates an example of generating a quantization unit in a quantization unit selection module according to embodiments;

FIG. 26 is a diagram for explaining operations of a prediction quantization parameter selection module and a residual quantization parameter derivation module according to embodiments;

FIG. 27 shows an inverse quantization and inverse transformation process of point cloud data according to embodiments;

FIG. 28 illustrates an operation process of an inverse quantization unit and an inverse quantization parameter derivation module according to embodiments;

FIG. 29 illustrates an inverse transformation process of an inverse transformation unit and inverse transformation method derivation module according to embodiments;

FIGS. 30 and 31 are diagrams to explain a process of generating restoration geometry information according to embodiments;

FIG. 32 shows an example of encoded point cloud data (bitstream) according to embodiments;

FIG. 33 illustrates an example of syntax of a sequence parameter set according to embodiments;

FIG. 34 illustrates an example of a syntax of a tile parameter set according to embodiments;

FIGS. 35A to 35C show an example of a syntax of a geometry node according to embodiments;

FIG. 36 illustrates an example of the geometry information encoder 36000 of a point cloud data transmission device according to embodiments;

FIG. 37 illustrates an example of the attribute information encoder 37000 of a point cloud data transmission device according to embodiments;

FIG. 38 illustrates an example of a geometry information decoder of a point cloud data reception device according to embodiments;

FIG. 39 illustrates an example of an attribute information decoder of a point cloud data reception device according to embodiments;

FIG. 40 illustrates an example of a method of transmitting point cloud data according to embodiments; and

FIG. 41 illustrates an example of a method for receiving point cloud data according to embodiments.

### DETAIL DESCRIPTION

Reference will now be made in detail to the preferred embodiments of the present disclosure, examples of which are illustrated in the accompanying drawings. The detailed description, which will be given below with reference to the accompanying drawings, is intended to explain exemplary embodiments of the present disclosure, rather than to show the only embodiments that may be implemented according to the present disclosure. The following detailed description includes specific details in order to provide a thorough understanding of the present disclosure. However, it will be apparent to those skilled in the art that the present disclosure may be practiced without such specific details.

Although most terms used in the present disclosure have been selected from general ones widely used in the art, some terms have been arbitrarily selected by the applicant and their meanings are explained in detail in the following description as needed. Thus, the present disclosure should be understood based upon the intended meanings of the terms rather than their simple names or meanings.

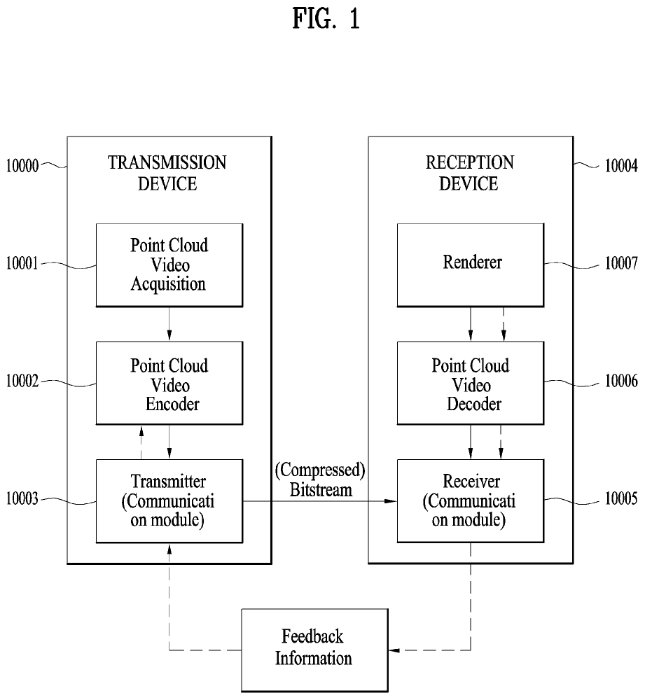

FIG. 1 shows an exemplary point cloud content providing system according to embodiments.

The point cloud content providing system illustrated in FIG. 1 may include a transmission device 10000 and a reception device 10004. The transmission device 10000 and the reception device 10004 are capable of wired or wireless communication to transmit and receive point cloud data.

The point cloud data transmission device 10000 according to the embodiments may secure and process point cloud video (or point cloud content) and transmit the same. According to embodiments, the transmission device 10000 may include a fixed station, a base transceiver system (BTS), a network, an artificial intelligence (AI) device and/or system, a robot, an AR/VR/XR device and/or server. According to embodiments, the transmission device 10000 may include a device, a robot, a vehicle, an AR/VR/XR device, a portable device, a home appliance, an Internet of Thing (IoT) device, and an AI device/server which are configured to perform communication with a base station and/or other wireless devices using a radio access technology (e.g., 5G New RAT (NR), Long Term Evolution (LTE)).

The transmission device 10000 according to the embodiments includes a point cloud video acquirer 10001, a point cloud video encoder 10002, and/or a transmitter (or communication module) 10003.

The point cloud video acquirer 10001 according to the embodiments acquires a point cloud video through a processing process such as capture, synthesis, or generation. The point cloud video is point cloud content represented by a point cloud, which is a set of points positioned in a 3D space, and may be referred to as point cloud video data. The point cloud video according to the embodiments may include one or more frames. One frame represents a still image/picture. Therefore, the point cloud video may include a point cloud image/frame/picture, and may be referred to as a point cloud image, frame, or picture.

The point cloud video encoder 10002 according to the embodiments encodes the acquired point cloud video data. The point cloud video encoder 10002 may encode the point cloud video data based on point cloud compression coding. The point cloud compression coding according to the embodiments may include geometry-based point cloud compression (G-PCC) coding and/or video-based point cloud compression (V-PCC) coding or next-generation coding. The point cloud compression coding according to the embodiments is not limited to the above-described embodiment. The point cloud video encoder 10002 may output a bitstream containing the encoded point cloud video data. The bitstream may contain not only the encoded point cloud video data, but also signaling information related to encoding of the point cloud video data.

The transmitter 10003 according to the embodiments transmits the bitstream containing the encoded point cloud video data. The bitstream according to the embodiments is encapsulated in a file or segment (for example, a streaming segment), and is transmitted over various networks such as a broadcasting network and/or a broadband network. Although not shown in the figure, the transmission device 10000 may include an encapsulator (or an encapsulation module) configured to perform an encapsulation operation. According to embodiments, the encapsulator may be included in the transmitter 10003. According to embodiments, the file or segment may be transmitted to the reception device 10004 over a network, or stored in a digital storage medium (e.g., USB, SD, CD, DVD, Blu-ray, HDD, SSD, etc.). The transmitter 10003 according to the embodiments is capable of wired/wireless communication with the reception device 10004 (or the receiver 10005) over a network of 4G, 5G, 6G, etc. In addition, the transmitter may perform a necessary data processing operation according to the network system (e.g., a 4G, 5G or 6G communication network system). The transmission device 10000 may transmit the encapsulated data in an on-demand manner.

The reception device 10004 according to the embodiments includes a receiver 10005, a point cloud video decoder 10006, and/or a renderer 10007. According to embodiments, the reception device 10004 may include a device, a robot, a vehicle, an AR/VR/XR device, a portable device, a home appliance, an Internet of Things (IoT) device, and an AI device/server which are configured to perform communication with a base station and/or other wireless devices using a radio access technology (e.g., 5G New RAT (NR), Long Term Evolution (LTE)).

The receiver 10005 according to the embodiments receives the bitstream containing the point cloud video data or the file/segment in which the bitstream is encapsulated from the network or storage medium. The receiver 10005 may perform necessary data processing according to the network system (for example, a communication network system of 4G, 5G, 6G, etc.). The receiver 10005 according to the embodiments may decapsulate the received file/segment and output a bitstream. According to embodiments, the receiver 10005 may include a decapsulator (or a decapsulation module) configured to perform a decapsulation operation. The decapsulator may be implemented as an element (or component) separate from the receiver 10005.

The point cloud video decoder 10006 decodes the bitstream containing the point cloud video data. The point cloud video decoder 10006 may decode the point cloud video data according to the method by which the point cloud video data is encoded (for example, in a reverse process of the operation of the point cloud video encoder 10002). Accordingly, the point cloud video decoder 10006 may decode the point cloud video data by performing point cloud decompression coding, which is the inverse process of the point cloud compression. The point cloud decompression coding includes G-PCC coding.

The renderer 10007 renders the decoded point cloud video data. The renderer 10007 may output point cloud content by rendering not only the point cloud video data but also audio data. According to embodiments, the renderer 10007 may include a display configured to display the point cloud content. According to embodiments, the display may be implemented as a separate device or component rather than being included in the renderer 10007.

The arrows indicated by dotted lines in the drawing represent a transmission path of feedback information acquired by the reception device 10004. The feedback information is information for reflecting interactivity with a user who consumes the point cloud content, and includes information about the user (e.g., head orientation information, viewport information, and the like). In particular, when the point cloud content is content for a service (e.g., self-driving service, etc.) that requires interaction with the user, the feedback information may be provided to the content transmitting side (e.g., the transmission device 10000) and/or the service provider. According to embodiments, the feedback information may be used in the reception device 10004 as well as the transmission device 10000, or may not be provided.

The head orientation information according to embodiments is information about the user's head position, orientation, angle, motion, and the like. The reception device 10004 according to the embodiments may calculate the viewport information based on the head orientation information. The viewport information may be information about a region of a point cloud video that the user is viewing. A viewpoint is a point through which the user is viewing the point cloud video, and may refer to a center point of the viewport region. That is, the viewport is a region centered on the viewpoint, and the size and shape of the region may be determined by a field of view (FOV). Accordingly, the reception device 10004 may extract the viewport information based on a vertical or horizontal FOV supported by the device in addition to the head orientation information. Also, the reception device 10004 performs gaze analysis or the like to check the way the user consumes a point cloud, a region that the user gazes at in the point cloud video, a gaze time, and the like. According to embodiments, the reception device 10004 may transmit feedback information including the result of the gaze analysis to the transmission device 10000. The feedback information according to the embodiments may be acquired in the rendering and/or display process. The feedback information according to the embodiments may be secured by one or more sensors included in the reception device 10004. According to embodiments, the feedback information may be secured by the renderer 10007 or a separate external element (or device, component, or the like). The dotted lines in FIG. 1 represent a process of transmitting the feedback information secured by the renderer 10007. The point cloud content providing system may process (encode/decode) point cloud data based on the feedback information. Accordingly, the point cloud video data decoder 10006 may perform a decoding operation based on the feedback information. The reception device 10004 may transmit the feedback information to the transmission device 10000. The transmission device 10000 (or the point cloud video data encoder 10002) may perform an encoding operation based on the feedback information. Accordingly, the point cloud content providing system may efficiently process necessary data (e.g., point cloud data corresponding to the user's head position) based on the feedback information rather than processing (encoding/decoding) the entire point cloud data, and provide point cloud content to the user.

According to embodiments, the transmission device 10000 may be called an encoder, a transmission device, a transmitter, or the like, and the reception device 10004 may be called a decoder, a receiving device, a receiver, or the like.

The point cloud data processed in the point cloud content providing system of FIG. 1 according to embodiments (through a series of processes of acquisition/encoding/transmission/decoding/rendering) may be referred to as point cloud content data or point cloud video data. According to embodiments, the point cloud content data may be used as a concept covering metadata or signaling information related to the point cloud data.

The elements of the point cloud content providing system illustrated in FIG. 1 may be implemented by hardware, software, a processor, and/or a combination thereof.

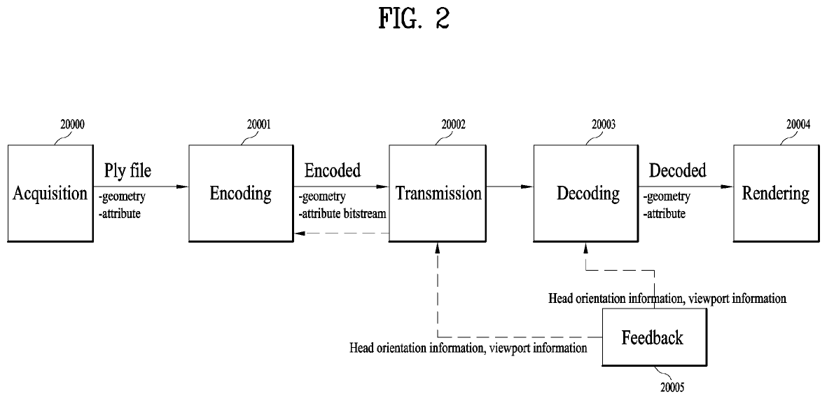

FIG. 2 is a block diagram illustrating a point cloud content providing operation according to embodiments.

The block diagram of FIG. 2 shows the operation of the point cloud content providing system described in FIG. 1. As described above, the point cloud content providing system may process point cloud data based on point cloud compression coding (e.g., G-PCC).

The point cloud content providing system according to the embodiments (for example, the point cloud transmission device 10000 or the point cloud video acquirer 10001) may acquire a point cloud video (20000). The point cloud video is represented by a point cloud belonging to a coordinate system for expressing a 3D space. The point cloud video according to the embodiments may include a Ply (Polygon File format or the Stanford Triangle format) file. When the point cloud video has one or more frames, the acquired point cloud video may include one or more Ply files. The Ply files contain point cloud data, such as point geometry and/or attributes. The geometry includes positions of points. The position of each point may be represented by parameters (for example, values of the X, Y, and Z axes) representing a three-dimensional coordinate system (e.g., a coordinate system composed of X, Y and Z axes). The attributes include attributes of points (e.g., information about texture, color (in YCbCr or RGB), reflectance r, transparency, etc. of each point). A point has one or more attributes. For example, a point may have an attribute that is a color, or two attributes that are color and reflectance. According to embodiments, the geometry may be called positions, geometry information, geometry data, or the like, and the attribute may be called attributes, attribute information, attribute data, or the like. The point cloud content providing system (for example, the point cloud transmission device 10000 or the point cloud video acquirer 10001) may secure point cloud data from information (e.g., depth information, color information, etc.) related to the acquisition process of the point cloud video.

The point cloud content providing system (for example, the transmission device 10000 or the point cloud video encoder 10002) according to the embodiments may encode the point cloud data (20001). The point cloud content providing system may encode the point cloud data based on point cloud compression coding. As described above, the point cloud data may include the geometry and attributes of a point. Accordingly, the point cloud content providing system may perform geometry encoding of encoding the geometry and output a geometry bitstream. The point cloud content providing system may perform attribute encoding of encoding attributes and output an attribute bitstream. According to embodiments, the point cloud content providing system may perform the attribute encoding based on the geometry encoding. The geometry bitstream and the attribute bitstream according to the embodiments may be multiplexed and output as one bitstream. The bitstream according to the embodiments may further contain signaling information related to the geometry encoding and attribute encoding.

The point cloud content providing system (for example, the transmission device 10000 or the transmitter 10003) according to the embodiments may transmit the encoded point cloud data (20002). As illustrated in FIG. 1, the encoded point cloud data may be represented by a geometry bitstream and an attribute bitstream. In addition, the encoded point cloud data may be transmitted in the form of a bitstream together with signaling information related to encoding of the point cloud data (for example, signaling information related to the geometry encoding and the attribute encoding). The point cloud content providing system may encapsulate a bitstream that carries the encoded point cloud data and transmit the same in the form of a file or segment.

The point cloud content providing system (for example, the reception device 10004 or the receiver 10005) according to the embodiments may receive the bitstream containing the encoded point cloud data. In addition, the point cloud content providing system (for example, the reception device 10004 or the receiver 10005) may demultiplex the bitstream.

The point cloud content providing system (e.g., the reception device 10004 or the point cloud video decoder 10005) may decode the encoded point cloud data (e.g., the geometry bitstream, the attribute bitstream) transmitted in the bitstream. The point cloud content providing system (for example, the reception device 10004 or the point cloud video decoder 10005) may decode the point cloud video data based on the signaling information related to encoding of the point cloud video data contained in the bitstream. The point cloud content providing system (for example, the reception device 10004 or the point cloud video decoder 10005) may decode the geometry bitstream to reconstruct the positions (geometry) of points. The point cloud content providing system may reconstruct the attributes of the points by decoding the attribute bitstream based on the reconstructed geometry. The point cloud content providing system (for example, the reception device 10004 or the point cloud video decoder 10005) may reconstruct the point cloud video based on the positions according to the reconstructed geometry and the decoded attributes.

The point cloud content providing system according to the embodiments (for example, the reception device 10004 or the renderer 10007) may render the decoded point cloud data (20004). The point cloud content providing system (for example, the reception device 10004 or the renderer 10007) may render the geometry and attributes decoded through the decoding process, using various rendering methods. Points in the point cloud content may be rendered to a vertex having a certain thickness, a cube having a specific minimum size centered on the corresponding vertex position, or a circle centered on the corresponding vertex position. All or part of the rendered point cloud content is provided to the user through a display (e.g., a VR/AR display, a general display, etc.).

The point cloud content providing system (e.g., the reception device 10004) according to the embodiments may secure feedback information (20005). The point cloud content providing system may encode and/or decode point cloud data based on the feedback information. The feedback information and the operation of the point cloud content providing system according to the embodiments are the same as the feedback information and the operation described with reference to FIG. 1, and thus detailed description thereof is omitted.

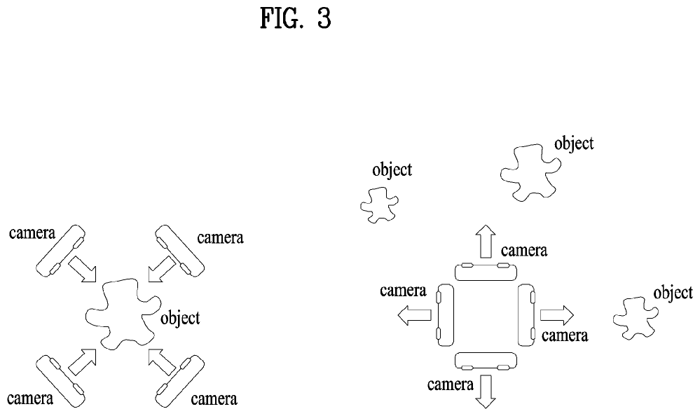

FIG. 3 illustrates an exemplary process of capturing a point cloud video according to embodiments.

FIG. 3 illustrates an exemplary point cloud video capture process of the point cloud content providing system described with reference to FIGS. 1 to 2.

Point cloud content includes a point cloud video (images and/or videos) representing an object and/or environment located in various 3D spaces (e.g., a 3D space representing a real environment, a 3D space representing a virtual environment, etc.). Accordingly, the point cloud content providing system according to the embodiments may capture a point cloud video using one or more cameras (e.g., an infrared camera capable of securing depth information, an RGB camera capable of extracting color information corresponding to the depth information, etc.), a projector (e.g., an infrared pattern projector to secure depth information), a LiDAR, or the like. The point cloud content providing system according to the embodiments may extract the shape of geometry composed of points in a 3D space from the depth information and extract the attributes of each point from the color information to secure point cloud data. An image and/or video according to the embodiments may be captured based on at least one of the inward-facing technique and the outward-facing technique.

The left part of FIG. 3 illustrates the inward-facing technique. The inward-facing technique refers to a technique of capturing images a central object with one or more cameras (or camera sensors) positioned around the central object. The inward-facing technique may be used to generate point cloud content providing a 360-degree image of a key object to the user (e.g., VR/AR content providing a 360-degree image of an object (e.g., a key object such as a character, player, object, or actor) to the user).

The right part of FIG. 3 illustrates the outward-facing technique. The outward-facing technique refers to a technique of capturing images an environment of a central object rather than the central object with one or more cameras (or camera sensors) positioned around the central object. The outward-facing technique may be used to generate point cloud content for providing a surrounding environment that appears from the user's point of view (e.g., content representing an external environment that may be provided to a user of a self-driving vehicle).

As shown in the figure, the point cloud content may be generated based on the capturing operation of one or more cameras. In this case, the coordinate system may differ among the cameras, and accordingly the point cloud content providing system may calibrate one or more cameras to set a global coordinate system before the capturing operation. In addition, the point cloud content providing system may generate point cloud content by synthesizing an arbitrary image and/or video with an image and/or video captured by the above-described capture technique. The point cloud content providing system may not perform the capturing operation described in FIG. 3 when it generates point cloud content representing a virtual space. The point cloud content providing system according to the embodiments may perform post-processing on the captured image and/or video. In other words, the point cloud content providing system may remove an unwanted area (for example, a background), recognize a space to which the captured images and/or videos are connected, and, when there is a spatial hole, perform an operation of filling the spatial hole.

The point cloud content providing system may generate one piece of point cloud content by performing coordinate transformation on points of the point cloud video secured from each camera. The point cloud content providing system may perform coordinate transformation on the points based on the coordinates of the position of each camera. Accordingly, the point cloud content providing system may generate content representing one wide range, or may generate point cloud content having a high density of points.

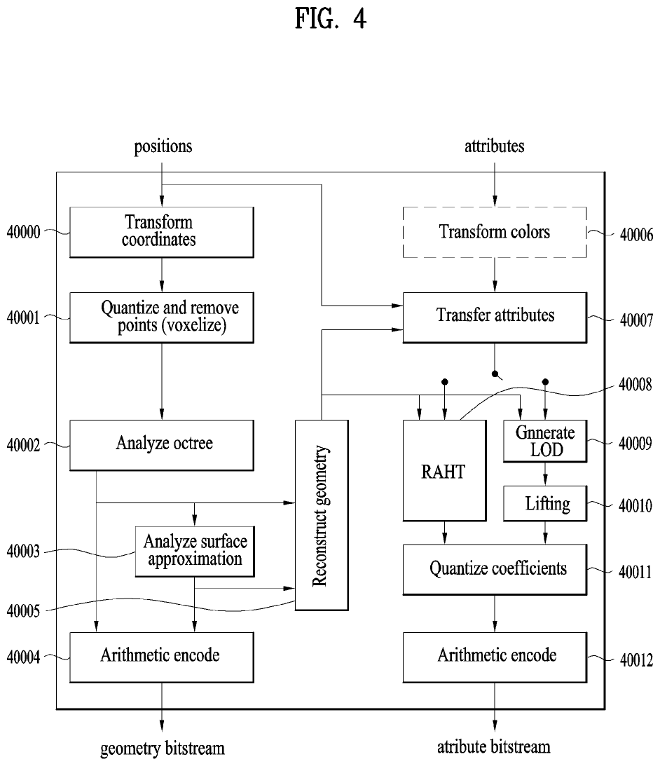

FIG. 4 illustrates an exemplary point cloud encoder according to embodiments.

FIG. 4 shows an example of the point cloud video encoder 10002 of FIG. 1. The point cloud encoder reconstructs and encodes point cloud data (e.g., positions and/or attributes of the points) to adjust the quality of the point cloud content (to, for example, lossless, lossy, or near-lossless) according to the network condition or applications. When the overall size of the point cloud content is large (e.g., point cloud content of 60 Gbps is given for 30 fps), the point cloud content providing system may fail to stream the content in real time. Accordingly, the point cloud content providing system may reconstruct the point cloud content based on the maximum target bitrate to provide the same in accordance with the network environment or the like.

As described with reference to FIGS. 1 and 2, the point cloud encoder may perform geometry encoding and attribute encoding. The geometry encoding is performed before the attribute encoding.

The point cloud encoder according to the embodiments includes a coordinate system transformer (Transform coordinates) 40000, a quantizer (Quantize and remove points (voxelize)) 40001, an octree analyzer (Analyze octree) 40002, and a surface approximation analyzer (Analyze surface approximation) 40003, an arithmetic encoder (Arithmetic encode) 40004, a geometry reconstructor (Reconstruct geometry) 40005, a color transformer (Transform colors) 40006, an attribute transformer (Transform attributes) 40007, a RAHT transformer (RAHT) 40008, an LOD generator (Generate LOD) 40009, a lifting transformer (Lifting) 40010, a coefficient quantizer (Quantize coefficients) 40011, and/or an arithmetic encoder (Arithmetic encode) 40012.

The coordinate system transformer 40000, the quantizer 40001, the octree analyzer 40002, the surface approximation analyzer 40003, the arithmetic encoder 40004, and the geometry reconstructor 40005 may perform geometry encoding. The geometry encoding according to the embodiments may include octree geometry coding, predictive tree geometry coding, direct coding, trisoup geometry encoding, and entropy encoding. The direct coding and trisoup geometry encoding are applied selectively or in combination. The geometry encoding is not limited to the above-described example.

As shown in the figure, the coordinate system transformer 40000 according to the embodiments receives positions and transforms the same into coordinates. For example, the positions may be transformed into position information in a three-dimensional space (for example, a three-dimensional space represented by an XYZ coordinate system). The position information in the three-dimensional space according to the embodiments may be referred to as geometry information.

The quantizer 40001 according to the embodiments quantizes the geometry. For example, the quantizer 40001 may quantize the points based on a minimum position value of all points (for example, a minimum value on each of the X, Y, and Z axes). The quantizer 40001 performs a quantization operation of multiplying the difference between the minimum position value and the position value of each point by a preset quantization scale value and then finding the nearest integer value by rounding the value obtained through the multiplication. Thus, one or more points may have the same quantized position (or position value). The quantizer 40001 according to the embodiments performs voxelization based on the quantized positions to reconstruct quantized points. As in the case of a pixel, which is the minimum unit containing 2D image/video information, points of point cloud content (or 3D point cloud video) according to the embodiments may be included in one or more voxels. The term voxel, which is a compound of volume and pixel, refers to a 3D cubic space generated when a 3D space is divided into units (unit=1.0) based on the axes representing the 3D space (e.g., X-axis, Y-axis, and Z-axis). The quantizer 40001 may match groups of points in the 3D space with voxels. According to embodiments, one voxel may include only one point. According to embodiments, one voxel may include one or more points. In order to express one voxel as one point, the position of the center of a voxel may be set based on the positions of one or more points included in the voxel. In this case, attributes of all positions included in one voxel may be combined and assigned to the voxel.

The octree analyzer 40002 according to the embodiments performs octree geometry coding (or octree coding) to present voxels in an octree structure. The octree structure represents points matched with voxels, based on the octal tree structure.

The surface approximation analyzer 40003 according to the embodiments may analyze and approximate the octree. The octree analysis and approximation according to the embodiments is a process of analyzing a region containing a plurality of points to efficiently provide octree and voxelization.

The arithmetic encoder 40004 according to the embodiments performs entropy encoding on the octree and/or the approximated octree. For example, the encoding scheme includes arithmetic encoding. As a result of the encoding, a geometry bitstream is generated.

The color transformer 40006, the attribute transformer 40007, the RAHT transformer 40008, the LOD generator 40009, the lifting transformer 40010, the coefficient quantizer 40011, and/or the arithmetic encoder 40012 perform attribute encoding. As described above, one point may have one or more attributes. The attribute encoding according to the embodiments is equally applied to the attributes that one point has. However, when an attribute (e.g., color) includes one or more elements, attribute encoding is independently applied to each element. The attribute encoding according to the embodiments includes color transform coding, attribute transform coding, region adaptive hierarchical transform (RAHT) coding, interpolation-based hierarchical nearest-neighbor prediction (prediction transform) coding, and interpolation-based hierarchical nearest-neighbor prediction with an update/lifting step (lifting transform) coding. Depending on the point cloud content, the RAHT coding, the prediction transform coding and the lifting transform coding described above may be selectively used, or a combination of one or more of the coding schemes may be used. The attribute encoding according to the embodiments is not limited to the above-described example.

The color transformer 40006 according to the embodiments performs color transform coding of transforming color values (or textures) included in the attributes. For example, the color transformer 40006 may transform the format of color information (for example, from RGB to YCbCr). The operation of the color transformer 40006 according to embodiments may be optionally applied according to the color values included in the attributes.

The geometry reconstructor 40005 according to the embodiments reconstructs (decompresses) the octree, the predictive tree and/or the approximated octree. The geometry reconstructor 40005 reconstructs the octree/voxels based on the result of analyzing the distribution of points. The reconstructed octree/voxels may be referred to as reconstructed geometry (restored geometry).

The attribute transformer 40007 according to the embodiments performs attribute transformation to transform the attributes based on the reconstructed geometry and/or the positions on which geometry encoding is not performed. As described above, since the attributes are dependent on the geometry, the attribute transformer 40007 may transform the attributes based on the reconstructed geometry information. For example, based on the position value of a point included in a voxel, the attribute transformer 40007 may transform the attribute of the point at the position. As described above, when the position of the center of a voxel is set based on the positions of one or more points included in the voxel, the attribute transformer 40007 transforms the attributes of the one or more points. When the trisoup geometry encoding is performed, the attribute transformer 40007 may transform the attributes based on the trisoup geometry encoding.

The attribute transformer 40007 may perform the attribute transformation by calculating the average of attributes or attribute values of neighboring points (e.g., color or reflectance of each point) within a specific position/radius from the position (or position value) of the center of each voxel. The attribute transformer 40007 may apply a weight according to the distance from the center to each point in calculating the average. Accordingly, each voxel has a position and a calculated attribute (or attribute value).

The attribute transformer 40007 may search for neighboring points existing within a specific position/radius from the position of the center of each voxel based on the K-D tree or the Morton code. The K-D tree is a binary search tree and supports a data structure capable of managing points based on the positions such that nearest neighbor search (NNS) may be performed quickly. The Morton code is generated by presenting coordinates (e.g., (x, y, z)) representing 3D positions of all points as bit values and mixing the bits. For example, when the coordinates all representing the position of a point are (5, 9, 1), the bit values for the coordinates are (0101, 1001, 0001). Mixing the bit values according to the bit index in order of z, y, and x yields 010001000111. This value is expressed as a decimal number of 1095. That is, the Morton code value of the point having coordinates (5, 9, 1) is 1095. The attribute transformer 40007 may order the points based on the Morton code values and perform NNS through a depth-first traversal process. After the attribute transformation operation, the K-D tree or the Morton code is used when the NNS is needed in another transformation process for attribute coding.

As shown in the figure, the transformed attributes are input to the RAHT transformer 40008 and/or the LOD generator 40009.

The RAHT transformer 40008 according to the embodiments performs RAHT coding for predicting attribute information based on the reconstructed geometry information. For example, the RAHT transformer 40008 may predict attribute information of a node at a higher level in the octree based on the attribute information associated with a node at a lower level in the octree.

The LOD generator 40009 according to the embodiments generates a level of detail (LOD) to perform prediction transform coding. The LOD according to the embodiments is a degree of detail of point cloud content. As the LOD value decrease, it indicates that the detail of the point cloud content is degraded. As the LOD value increases, it indicates that the detail of the point cloud content is enhanced. Points may be classified by the LOD.

The lifting transformer 40010 according to the embodiments performs lifting transform coding of transforming the attributes a point cloud based on weights. As described above, lifting transform coding may be optionally applied.

The coefficient quantizer 40011 according to the embodiments quantizes the attribute-coded attributes based on coefficients.

The arithmetic encoder 40012 according to the embodiments encodes the quantized attributes based on arithmetic coding.

Although not shown in the figure, the elements of the point cloud encoder of FIG. 4 may be implemented by hardware including one or more processors or integrated circuits configured to communicate with one or more memories included in the point cloud providing device, software, firmware, or a combination thereof. The one or more processors may perform at least one of the operations and/or functions of the elements of the point cloud encoder of FIG. 4 described above. Additionally, the one or more processors may operate or execute a set of software programs and/or instructions for performing the operations and/or functions of the elements of the point cloud encoder of FIG. 4. The one or more memories according to the embodiments may include a high speed random access memory, or include a non-volatile memory (e.g., one or more magnetic disk storage devices, flash memory devices, or other non-volatile solid-state memory devices).

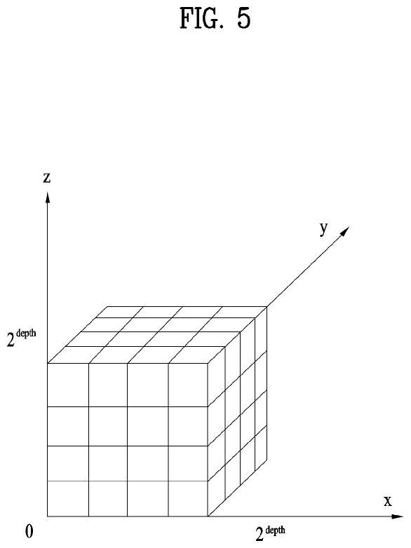

FIG. 5 shows an example of voxels according to embodiments.

FIG. 5 shows voxels positioned in a 3D space represented by a coordinate system composed of three axes, which are the X-axis, the Y-axis, and the Z-axis. As described with reference to FIG. 4, the point cloud encoder (e.g., the quantizer 40001) may perform voxelization. Voxel refers to a 3D cubic space generated when a 3D space is divided into units (unit=1.0) based on the axes representing the 3D space (e.g., X-axis, Y-axis, and Z-axis). FIG. 5 shows an example of voxels generated through an octree structure in which a cubical axis-aligned bounding box defined by two poles (0, 0, 0) and (2^{d}, 2^{d}, 2^{d}) is recursively subdivided. One voxel includes at least one point. The spatial coordinates of a voxel may be estimated from the positional relationship with a voxel group. As described above, a voxel has an attribute (such as color or reflectance) like pixels of a 2D image/video. The details of the voxel are the same as those described with reference to FIG. 4, and therefore a description thereof is omitted.

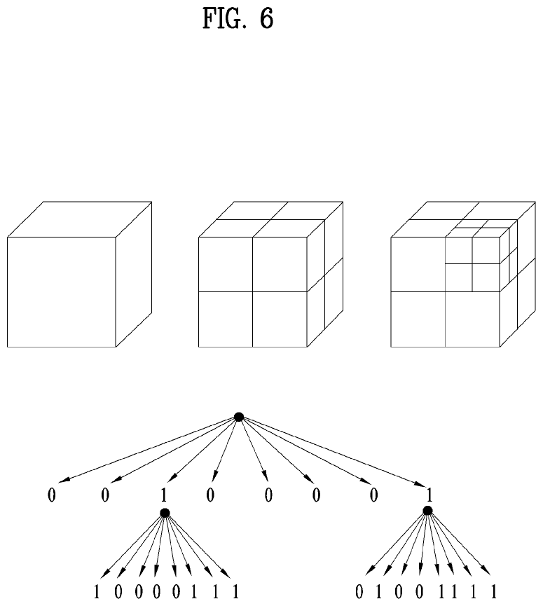

FIG. 6 shows an example of an octree and occupancy code according to embodiments.

As described with reference to FIGS. 1 to 4, the point cloud content providing system (point cloud video encoder 10002) or the point cloud encoder (for example, the octree analyzer 40002) performs octree geometry coding (or octree coding) based on an octree structure to efficiently manage the region and/or position of the voxel.

The upper part of FIG. 6 shows an octree structure. The 3D space of the point cloud content according to the embodiments is represented by axes (e.g., X-axis, Y-axis, and Z-axis) of the coordinate system. The octree structure is created by recursive subdividing of a cubical axis-aligned bounding box defined by two poles (0, 0, 0) and (2^{d}, 2^{d}, 2^{d}) Here, 2d may be set to a value constituting the smallest bounding box surrounding all points of the point cloud content (or point cloud video). Here, d denotes the depth of the octree. The value of d is determined in the following equation. In the following equation, (x^{int}ₙ, y^{int}ₙ, z^{int}ₙ) denotes the positions (or position values) of quantized points.

d=Ceil(Log 2(Max(xₙ^{int},yₙ^{int},zₙ^{int},n=1, . . . ,N)+1))

As shown in the middle of the upper part of FIG. 6, the entire 3D space may be divided into eight spaces according to partition. Each divided space is represented by a cube with six faces. As shown in the upper right of FIG. 6, each of the eight spaces is divided again based on the axes of the coordinate system (e.g., X-axis, Y-axis, and Z-axis). Accordingly, each space is divided into eight smaller spaces. The divided smaller space is also represented by a cube with six faces. This partitioning scheme is applied until the leaf node of the octree becomes a voxel.

The lower part of FIG. 6 shows an octree occupancy code. The occupancy code of the octree is generated to indicate whether each of the eight divided spaces generated by dividing one space contains at least one point. Accordingly, a single occupancy code is represented by eight child nodes. Each child node represents the occupancy of a divided space, and the child node has a value in 1 bit. Accordingly, the occupancy code is represented as an 8-bit code. That is, when at least one point is contained in the space corresponding to a child node, the node is assigned a value of 1. When no point is contained in the space corresponding to the child node (the space is empty), the node is assigned a value of 0. Since the occupancy code shown in FIG. 6 is 00100001, it indicates that the spaces corresponding to the third child node and the eighth child node among the eight child nodes each contain at least one point. As shown in the figure, each of the third child node and the eighth child node has eight child nodes, and the child nodes are represented by an 8-bit occupancy code. The figure shows that the occupancy code of the third child node is 10000111, and the occupancy code of the eighth child node is 01001111. The point cloud encoder (for example, the arithmetic encoder 40004) according to the embodiments may perform entropy encoding on the occupancy codes. In order to increase the compression efficiency, the point cloud encoder may perform intra/inter-coding on the occupancy codes. The reception device (for example, the reception device 10004 or the point cloud video decoder 10006) according to the embodiments reconstructs the octree based on the occupancy codes.

The point cloud encoder (for example, the point cloud encoder of FIG. 4 or the octree analyzer 40002) according to the embodiments may perform voxelization and octree coding to store the positions of points. However, points are not always evenly distributed in the 3D space, and accordingly there may be a specific region in which fewer points are present. Accordingly, it is inefficient to perform voxelization for the entire 3D space. For example, when a specific region contains few points, voxelization does not need to be performed in the specific region.

Accordingly, for the above-described specific region (or a node other than the leaf node of the octree), the point cloud encoder according to the embodiments may skip voxelization and perform direct coding to directly code the positions of points included in the specific region. The coordinates of a direct coding point according to the embodiments are referred to as direct coding mode (DCM). The point cloud encoder according to the embodiments may also perform trisoup geometry encoding, which is to reconstruct the positions of the points in the specific region (or node) based on voxels, based on a surface model. The trisoup geometry encoding is geometry encoding that represents an object as a series of triangular meshes. Accordingly, the point cloud decoder may generate a point cloud from the mesh surface. The direct coding and trisoup geometry encoding according to the embodiments may be selectively performed. In addition, the direct coding and trisoup geometry encoding according to the embodiments may be performed in combination with octree geometry coding (or octree coding).

To perform direct coding, the option to use the direct mode for applying direct coding should be activated. A node to which direct coding is to be applied is not a leaf node, and points less than a threshold should be present within a specific node. In addition, the total number of points to which direct coding is to be applied should not exceed a preset threshold. When the conditions above are satisfied, the point cloud encoder (or the arithmetic encoder 40004) according to the embodiments may perform entropy coding on the positions (or position values) of the points.

The point cloud encoder (for example, the surface approximation analyzer 40003) according to the embodiments may determine a specific level of the octree (a level less than the depth d of the octree), and the surface model may be used staring with that level to perform trisoup geometry encoding to reconstruct the positions of points in the region of the node based on voxels (Trisoup mode). The point cloud encoder according to the embodiments may specify a level at which trisoup geometry encoding is to be applied. For example, when the specific level is equal to the depth of the octree, the point cloud encoder does not operate in the trisoup mode. In other words, the point cloud encoder according to the embodiments may operate in the trisoup mode only when the specified level is less than the value of depth of the octree. The 3D cube region of the nodes at the specified level according to the embodiments is called a block. One block may include one or more voxels. The block or voxel may correspond to a brick. Geometry is represented as a surface within each block. The surface according to embodiments may intersect with each edge of a block at most once.

One block has 12 edges, and accordingly there are at least 12 intersections in one block. Each intersection is called a vertex (or apex). A vertex present along an edge is detected when there is at least one occupied voxel adjacent to the edge among all blocks sharing the edge. The occupied voxel according to the embodiments refers to a voxel containing a point. The position of the vertex detected along the edge is the average position along the edge of all voxels adjacent to the edge among all blocks sharing the edge.

Once the vertex is detected, the point cloud encoder according to the embodiments may perform entropy encoding on the starting point (x, y, z) of the edge, the direction vector (Δx, Δy, Δz) of the edge, and the vertex position value (relative position value within the edge). When the trisoup geometry encoding is applied, the point cloud encoder according to the embodiments (for example, the geometry reconstructor 40005) may generate restored geometry (reconstructed geometry) by performing the triangle reconstruction, up-sampling, and voxelization processes.

The vertices positioned at the edge of the block determine a surface that passes through the block. The surface according to the embodiments is a non-planar polygon. In the triangle reconstruction process, a surface represented by a triangle is reconstructed based on the starting point of the edge, the direction vector of the edge, and the position values of the vertices. The triangle reconstruction process is performed by: i) calculating the centroid value of each vertex, ii) subtracting the center value from each vertex value, and iii) estimating the sum of the squares of the values obtained by the subtraction.

$$i ) [ \begin{matrix}{μ}_{x} \\ {μ}_{y} \\ {μ}_{z}\end{matrix} ] = \frac{1}{n} {\sum }_{i = 1}^{n} [ \begin{matrix}{x}_{i} \\ {y}_{i} \\ {z}_{i}\end{matrix} ] ;$$

$$ii ) [ \begin{matrix}{\overline{x}}_{i} \\ {\overline{y}}_{i} \\ {\overline{z}}_{i}\end{matrix} ] = [ \begin{matrix}{x}_{i} \\ {y}_{i} \\ {z}_{i}\end{matrix} ] - [ \begin{matrix}{μ}_{x} \\ {μ}_{y} \\ {μ}_{z}\end{matrix} ] ;$$

$$iii ) [ \begin{matrix}{σ}_{x}^{2} \\ {σ}_{y}^{2} \\ {σ}_{z}^{2}\end{matrix} ] = {\sum }_{i = 1}^{n} [ \begin{matrix}{\overline{x}}_{i}^{2} \\ {\overline{y}}_{i}^{2} \\ {\overline{z}}_{i}^{2}\end{matrix} ]$$

The minimum value of the sum is estimated, and the projection process is performed according to the axis with the minimum value. For example, when the element x is the minimum, each vertex is projected on the x-axis with respect to the center of the block, and projected on the (y, z) plane. When the values obtained through projection on the (y, z) plane are (ai, bi), the value of 0 is estimated through a tan 2(bi, ai), and the vertices are ordered based on the value of 0. The table below shows a combination of vertices for creating a triangle according to the number of the vertices. The vertices are ordered from 1 to n. The table below shows that for four vertices, two triangles may be constructed according to combinations of vertices. The first triangle may consist of vertices 1, 2, and 3 among the ordered vertices, and the second triangle may consist of vertices 3, 4, and 1 among the ordered vertices.

TABLE 2-1
Triangles formed from vertices ordered 1, . . . , n

| n | triangles |
|---|---|
| 3 | (1, 2, 3) |
| 4 | (1, 2, 3), (3, 4, 1) |
| 5 | (1, 2, 3), (3, 4, 5), (5, 1, 3) |
| 6 | (1, 2, 3), (3, 4, 5), (5, 6, 1), (1, 3, 5) |
| 7 | (1, 2, 3), (3, 4, 5), (5, 6, 7), (7, 1, 3), (3, 5, 7) |
| 8 | (1, 2, 3), (3, 4, 5), (5, 6, 7), (7, 8, 1), (1, 3, 5), (5, 7, 1) |
| 9 | (1, 2, 3), (3, 4, 5), (5, 6, 7), (7, 8, 9), (9, 1, 3), (3, 5, 7), (7, 9, 3) |
| 10 | (1, 2, 3), (3, 4, 5), (5, 6, 7), (7, 8, 9), (9, 10, 1), (1, 3, 5), (5, 7, 9), |
| | (9, 1, 5) |
| 11 | (1, 2, 3), (3, 4, 5), (5, 6, 7), (7, 8, 9), (9, 10, 11), (11, 1, 3), (3, 5, 7), |
| | (7, 9, 11), (11, 3, 7) |
| 12 | (1, 2, 3), (3, 4, 5), (5, 6, 7), (7, 8, 9), (9, 10, 11), (11, 12, 1), (1, 3, |
| | 5), (5, 7, 9), (9, 11, 1), (1, 5, 9) |

The upsampling process is performed to add points in the middle along the edge of the triangle and perform voxelization. The added points are generated based on the upsampling factor and the width of the block. The added points are called refined vertices. The point cloud encoder according to the embodiments may voxelize the refined vertices. In addition, the point cloud encoder may perform attribute encoding based on the voxelized positions (or position values).

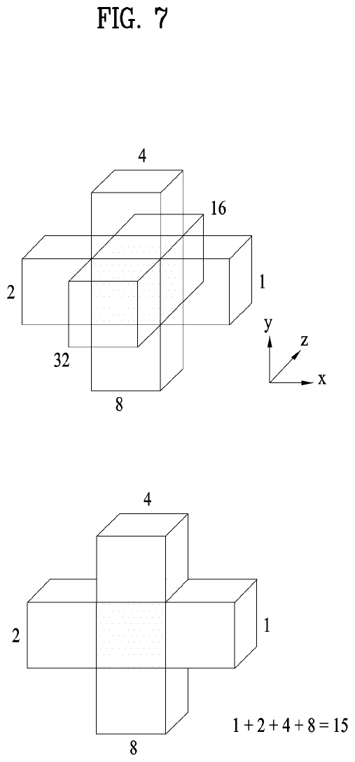

FIG. 7 shows an example of a neighbor node pattern according to embodiments.

In order to increase the compression efficiency of the point cloud video, the point cloud encoder according to the embodiments may perform entropy coding based on context adaptive arithmetic coding.

As described with reference to FIGS. 1 to 6, the point cloud content providing system or the point cloud encoder (for example, the point cloud video encoder 10002, the point cloud encoder or arithmetic encoder 40004 of FIG. 4) may perform entropy coding on the occupancy code immediately. In addition, the point cloud content providing system or the point cloud encoder may perform entropy encoding (intra encoding) based on the occupancy code of the current node and the occupancy of neighboring nodes, or perform entropy encoding (inter encoding) based on the occupancy code of the previous frame. A frame according to embodiments represents a set of point cloud videos generated at the same time. The compression efficiency of intra encoding/inter encoding according to the embodiments may depend on the number of neighboring nodes that are referenced. When the bits increase, the operation becomes complicated, but the encoding may be biased to one side, which may increase the compression efficiency. For example, when a 3-bit context is given, coding needs to be performed using 23=8 methods. The part divided for coding affects the complexity of implementation. Accordingly, it is necessary to meet an appropriate level of compression efficiency and complexity.

FIG. 7 illustrates a process of obtaining an occupancy pattern based on the occupancy of neighbor nodes. The point cloud encoder according to the embodiments determines occupancy of neighbor nodes of each node of the octree and obtains a value of a neighbor pattern. The neighbor node pattern is used to infer the occupancy pattern of the node. The left part of FIG. 7 shows a cube corresponding to a node (a cube positioned in the middle) and six cubes (neighbor nodes) sharing at least one face with the cube. The nodes shown in the figure are nodes of the same depth. The numbers shown in the figure represent weights (1, 2, 4, 8, 16, and 32) associated with the six nodes, respectively. The weights are assigned sequentially according to the positions of neighboring nodes.

The right part of FIG. 7 shows neighbor node pattern values. A neighbor node pattern value is the sum of values multiplied by the weight of an occupied neighbor node (a neighbor node having a point). Accordingly, the neighbor node pattern values are 0 to 63. When the neighbor node pattern value is 0, it indicates that there is no node having a point (no occupied node) among the neighbor nodes of the node. When the neighbor node pattern value is 63, it indicates that all neighbor nodes are occupied nodes. As shown in the figure, since neighbor nodes to which weights 1, 2, 4, and 8 are assigned are occupied nodes, the neighbor node pattern value is 15, the sum of 1, 2, 4, and 8. The point cloud encoder may perform coding according to the neighbor node pattern value (for example, when the neighbor node pattern value is 63, 64 kinds of coding may be performed). According to embodiments, the point cloud encoder may reduce coding complexity by changing a neighbor node pattern value (for example, based on a table by which 64 is changed to 10 or 6).

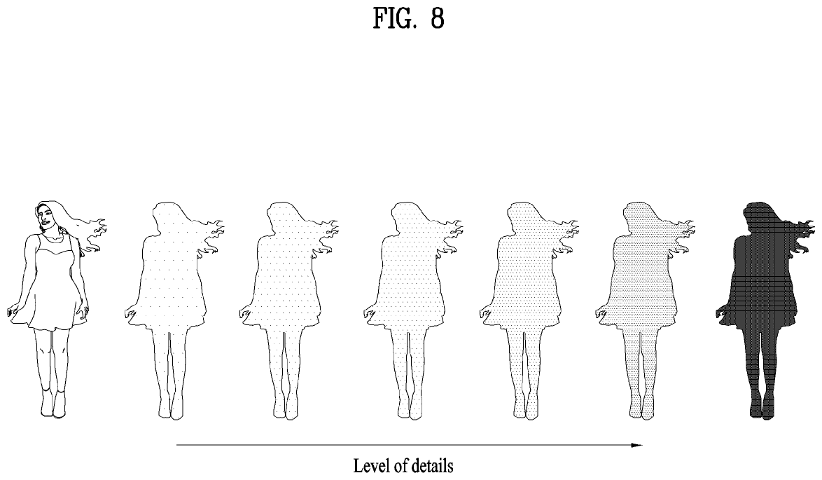

FIG. 8 illustrates an example of point configuration in each LOD according to embodiments.

As described with reference to FIGS. 1 to 7, encoded geometry is reconstructed (decompressed) before attribute encoding is performed. When direct coding is applied, the geometry reconstruction operation may include changing the placement of direct coded points (e.g., placing the direct coded points in front of the point cloud data). When trisoup geometry encoding is applied, the geometry reconstruction process is performed through triangle reconstruction, up-sampling, and voxelization. Since the attribute depends on the geometry, attribute encoding is performed based on the reconstructed geometry.

The point cloud encoder (for example, the LOD generator 40009) may classify (reorganize) points by LOD. The figure shows the point cloud content corresponding to LODs. The leftmost picture in the figure represents original point cloud content. The second picture from the left of the figure represents distribution of the points in the lowest LOD, and the rightmost picture in the figure represents distribution of the points in the highest LOD. That is, the points in the lowest LOD are sparsely distributed, and the points in the highest LOD are densely distributed. That is, as the LOD rises in the direction pointed by the arrow indicated at the bottom of the figure, the space (or distance) between points is narrowed.

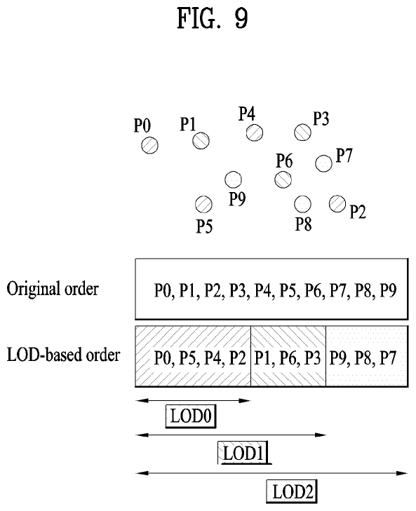

FIG. 9 illustrates an example of point configuration for each LOD according to embodiments.

As described with reference to FIGS. 1 to 8, the point cloud content providing system, or the point cloud encoder (for example, the point cloud video encoder 10002, the point cloud encoder of FIG. 4, or the LOD generator 40009) may generates an LOD. The LOD is generated by reorganizing the points into a set of refinement levels according to a set LOD distance value (or a set of Euclidean distances). The LOD generation process is performed not only by the point cloud encoder, but also by the point cloud decoder.

The upper part of FIG. 9 shows examples (P0 to P9) of points of the point cloud content distributed in a 3D space. In FIG. 9, the original order represents the order of points P0 to P9 before LOD generation. In FIG. 9, the LOD based order represents the order of points according to the LOD generation. Points are reorganized by LOD. Also, a high LOD contains the points belonging to lower LODs. As shown in FIG. 9, LOD0 contains P0, P5, P4 and P2. LOD1 contains the points of LOD0, P1, P6 and P3. LOD2 contains the points of LOD0, the points of LOD1, P9, P8 and P7.

As described with reference to FIG. 4, the point cloud encoder according to the embodiments may perform prediction transform coding, lifting transform coding, and RAHT transform coding selectively or in combination.

The point cloud encoder according to the embodiments may generate a predictor for points to perform prediction transform coding for setting a predicted attribute (or predicted attribute value) of each point. That is, N predictors may be generated for N points. The predictor according to the embodiments may calculate a weight (=1/distance) based on the LOD value of each point, indexing information about neighboring points present within a set distance for each LOD, and a distance to the neighboring points.

The predicted attribute (or attribute value) according to the embodiments is set to the average of values obtained by multiplying the attributes (or attribute values) (e.g., color, reflectance, etc.) of neighbor points set in the predictor of each point by a weight (or weight value) calculated based on the distance to each neighbor point. The point cloud encoder according to the embodiments (for example, the coefficient quantizer 40011) may quantize and inversely quantize the residuals (which may be called residual attributes, residual attribute values, attribute residual value or attribute prediction residuals) obtained by subtracting a predicted attribute (attribute value) from the attribute (attribute value) of each point. The quantization process is configured as shown in the following table.

TABLE 1
Attribute prediction residuals quantization pseudo code

int PCCQuantization(int value, int quantStep) {
if( value >=0) {
return floor(value / quantStep + 1.0 / 3.0);
} else {
return −floor(−value / quantStep + 1.0 / 3.0);
}
}

TABLE 2
Attribute prediction residuals inverse quantization pseudo code

int PCCInverseQuantization(int value, int quantStep) {
if( quantStep ==0) {
return value;
} else {
return value * quantStep;
}
}

When the predictor of each point has neighbor points, the point cloud encoder (e.g., the arithmetic encoder 40012) according to the embodiments may perform entropy coding on the quantized and inversely quantized residual values as described above. When the predictor of each point has no neighbor point, the point cloud encoder according to the embodiments (for example, the arithmetic encoder 40012) may perform entropy coding on the attributes of the corresponding point without performing the above-described operation.

The point cloud encoder according to the embodiments (for example, the lifting transformer 40010) may generate a predictor of each point, set the calculated LOD and register neighbor points in the predictor, and set weights according to the distances to neighbor points to perform lifting transform coding. The lifting transform coding according to the embodiments is similar to the above-described prediction transform coding, but differs therefrom in that weights are cumulatively applied to attribute values. The process of cumulatively applying weights to the attribute values according to embodiments is configured as follows.

1) Create an array Quantization Weight (QW) for storing the weight value of each point. The initial value of all elements of QW is 1.0. Multiply the QW values of the predictor indexes of the neighbor nodes registered in the predictor by the weight of the predictor of the current point, and add the values obtained by the multiplication.

2) Lift prediction process: Subtract the value obtained by multiplying the attribute value of the point by the weight from the existing attribute value to calculate a predicted attribute value.

3) Create temporary arrays called updateweight and update and initialize the temporary arrays to zero.

4) Cumulatively add the weights calculated by multiplying the weights calculated for all predictors by a weight stored in the QW corresponding to a predictor index to the updateweight array as indexes of neighbor nodes. Cumulatively add, to the update array, a value obtained by multiplying the attribute value of the index of a neighbor node by the calculated weight.

5) Lift update process: Divide the attribute values of the update array for all predictors by the weight value of the updateweight array of the predictor index, and add the existing attribute value to the values obtained by the division.

6) Calculate predicted attributes by multiplying the attribute values updated through the lift update process by the weight updated through the lift prediction process (stored in the QW) for all predictors. The point cloud encoder (e.g., coefficient quantizer 40011) according to the embodiments quantizes the predicted attribute values. In addition, the point cloud encoder (e.g., the arithmetic encoder 40012) performs entropy coding on the quantized attribute values.

The point cloud encoder (for example, the RAHT transformer 40008) according to the embodiments may perform RAHT transform coding in which attributes of nodes of a higher level are predicted using the attributes associated with nodes of a lower level in the octree. RAHT transform coding is an example of attribute intra coding through an octree backward scan. The point cloud encoder according to the embodiments scans the entire region from the voxel and repeats the merging process of merging the voxels into a larger block at each step until the root node is reached. The merging process according to the embodiments is performed only on the occupied nodes. The merging process is not performed on the empty node. The merging process is performed on an upper node immediately above the empty node.

The equation below represents a RAHT transformation matrix. In the equation, gₗ_{_{x,y,z}} denotes the average attribute value of voxels at level l. gₗ_{_{x,y,z}} may be calculated based on gₗ₊₁_{_{2x,y,z}} and gₗ₊₁_{_{2x+1,y,z}}. The weights for gₗ_{_{2x,y,z}} and gₗ_{_{2x+1,y,z}} are w1=wₗ_{_{2x,y,z}} and w2=wₗ_{_{2x+1,y,z}}.

$$⌈ \begin{matrix}{ℊ}_{l - {1}_{x , y , z}} \\ {h}_{l - {1}_{x , y , z}}\end{matrix} ⌉ = {T}_{w 1 w 2} ⌈ \begin{matrix}{ℊ}_{{l}_{2 x , y , z}} \\ {ℊ}_{{l}_{2 x + 1 , y , z}}\end{matrix} ⌉ , {T}_{w 1 w 2} = \frac{1}{\sqrt{w 1 + w 2}} [ \begin{matrix}\sqrt{w 1} & \sqrt{w 2} \\ - \sqrt{w 2} & \sqrt{w 1}\end{matrix} ]$$

Here, gₗ₋₁ _{_{x,y,z}} is a low-pass value and is used in the merging process at the next higher level. hₗ₋₁ _{_{x,y,z}} denotes high-pass coefficients. The high-pass coefficients at each step are quantized and subjected to entropy coding (for example, encoding by the arithmetic encoder 400012). The weights are calculated as wₗ_{_{−1x,y,z}}=wₗ_{_{2x,y,z}}+wₗ_{_{2x+1,y,z}}. The root node is created through the g₁_{_{0,0,0}} and g₁_{_{0,0,1}} as follows.

$$⌈ \begin{matrix}ℊDC \\ {h}_{{0}_{0 , 0 , 0}}\end{matrix} ⌉ = {T}_{w 1000 w 1001} ⌈ \begin{matrix}{ℊ}_{{1}_{0 , 0 , 0 z}} \\ {ℊ}_{{1}_{0 , 0 , 1}}\end{matrix} ⌉$$

The gDC value is also quantized and entropy coded like the high-pass coefficients.

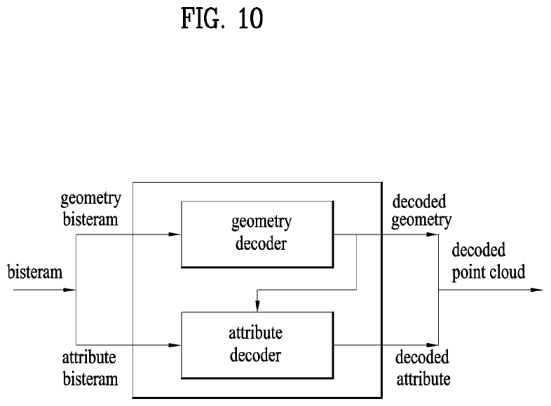

FIG. 10 illustrates a point cloud decoder according to embodiments.

The point cloud decoder illustrated in FIG. 10 is an example of the point cloud video decoder 10006 described in FIG. 1, and may perform the same or similar operations as the operations of the point cloud video decoder 10006 illustrated in FIG. 1. As shown in the figure, the point cloud decoder may receive a geometry bitstream and an attribute bitstream contained in one or more bitstreams. The point cloud decoder includes a geometry decoder and an attribute decoder. The geometry decoder performs geometry decoding on the geometry bitstream and outputs decoded geometry. The attribute decoder performs attribute decoding based on the decoded geometry and the attribute bitstream, and outputs decoded attributes. The decoded geometry and decoded attributes are used to reconstruct point cloud content (a decoded point cloud).

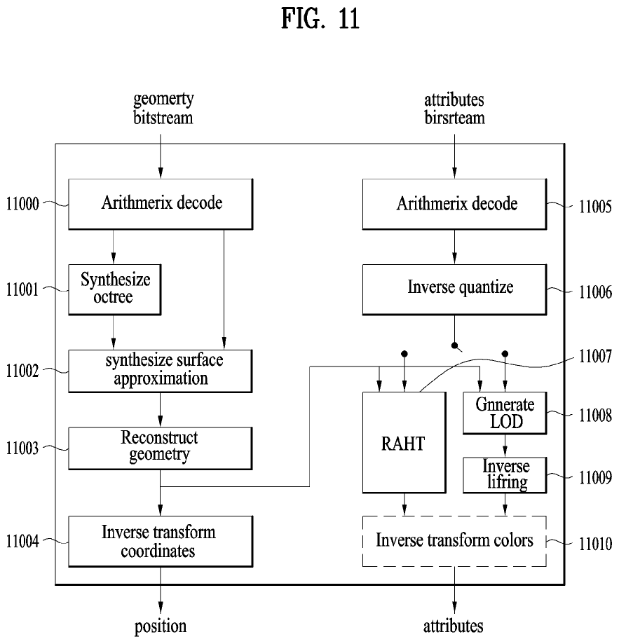

FIG. 11 illustrates a point cloud decoder according to embodiments.

The point cloud decoder illustrated in FIG. 11 is an example of the point cloud decoder illustrated in FIG. 10, and may perform a decoding operation, which is an inverse process of the encoding operation of the point cloud encoder illustrated in FIGS. 1 to 9.

As described with reference to FIGS. 1 and 10, the point cloud decoder may perform geometry decoding and attribute decoding. The geometry decoding is performed before the attribute decoding.

The point cloud decoder according to the embodiments includes an arithmetic decoder (Arithmetic decode) 11000, an octree synthesizer (Synthesize octree) 11001, a surface approximation synthesizer (Synthesize surface approximation) 11002, and a geometry reconstructor (Reconstruct geometry) 11003, a coordinate inverse transformer (Inverse transform coordinates) 11004, an arithmetic decoder (Arithmetic decode) 11005, an inverse quantizer (Inverse quantize) 11006, a RAHT transformer 11007, an LOD generator (Generate LOD) 11008, an inverse lifter (inverse lifting) 11009, and/or a color inverse transformer (Inverse transform colors) 11010.

The arithmetic decoder 11000, the octree synthesizer 11001, the surface approximation synthesizer 11002, and the geometry reconstructor 11003, and the coordinate inverse transformer 11004 may perform geometry decoding. The geometry decoding according to the embodiments may include direct coding and trisoup geometry decoding. The direct coding and trisoup geometry decoding are selectively applied. The geometry decoding is not limited to the above-described example, and is performed as an inverse process of the geometry encoding described with reference to FIGS. 1 to 9.

The arithmetic decoder 11000 according to the embodiments decodes the received geometry bitstream based on the arithmetic coding. The operation of the arithmetic decoder 11000 corresponds to the inverse process of the arithmetic encoder 40004.

The octree synthesizer 11001 according to the embodiments may generate an octree by acquiring an occupancy code from the decoded geometry bitstream (or information on the geometry secured as a result of decoding). The occupancy code is configured as described in detail with reference to FIGS. 1 to 9.

When the trisoup geometry encoding is applied, the surface approximation synthesizer 11002 according to the embodiments may synthesize a surface based on the decoded geometry and/or the generated octree.

The geometry reconstructor 11003 according to the embodiments may regenerate geometry based on the surface and/or the decoded geometry. As described with reference to FIGS. 1 to 9, direct coding and trisoup geometry encoding are selectively applied.

Accordingly, the geometry reconstructor 11003 directly imports and adds position information about the points to which direct coding is applied. When the trisoup geometry encoding is applied, the geometry reconstructor 11003 may reconstruct the geometry by performing the reconstruction operations of the geometry reconstructor 40005, for example, triangle reconstruction, up-sampling, and voxelization. Details are the same as those described with reference to FIG. 6, and thus description thereof is omitted. The reconstructed geometry may include a point cloud picture or frame that does not contain attributes.

The coordinate inverse transformer 11004 according to the embodiments may acquire positions of the points by transforming the coordinates based on the reconstructed geometry.

The arithmetic decoder 11005, the inverse quantizer 11006, the RAHT transformer 11007, the LOD generator 11008, the inverse lifter 11009, and/or the color inverse transformer 11010 may perform the attribute decoding described with reference to FIG. 10. The attribute decoding according to the embodiments includes region adaptive hierarchical transform (RAHT) decoding, interpolation-based hierarchical nearest-neighbor prediction (prediction transform) decoding, and interpolation-based hierarchical nearest-neighbor prediction with an update/lifting step (lifting transform) decoding. The three decoding schemes described above may be used selectively, or a combination of one or more decoding schemes may be used. The attribute decoding according to the embodiments is not limited to the above-described example.

The arithmetic decoder 11005 according to the embodiments decodes the attribute bitstream by arithmetic coding.

The inverse quantizer 11006 according to the embodiments inversely quantizes the information about the decoded attribute bitstream or attributes secured as a result of the decoding, and outputs the inversely quantized attributes (or attribute values). The inverse quantization may be selectively applied based on the attribute encoding of the point cloud encoder.

According to embodiments, the RAHT transformer 11007, the LOD generator 11008, and/or the inverse lifter 11009 may process the reconstructed geometry and the inversely quantized attributes. As described above, the RAHT transformer 11007, the LOD generator 11008, and/or the inverse lifter 11009 may selectively perform a decoding operation corresponding to the encoding of the point cloud encoder.

The color inverse transformer 11010 according to the embodiments performs inverse transform coding to inversely transform a color value (or texture) included in the decoded attributes. The operation of the color inverse transformer 11010 may be selectively performed based on the operation of the color transformer 40006 of the point cloud encoder.

Although not shown in the figure, the elements of the point cloud decoder of FIG. 11 may be implemented by hardware including one or more processors or integrated circuits configured to communicate with one or more memories included in the point cloud providing device, software, firmware, or a combination thereof. The one or more processors may perform at least one or more of the operations and/or functions of the elements of the point cloud decoder of FIG. 11 described above. Additionally, the one or more processors may operate or execute a set of software programs and/or instructions for performing the operations and/or functions of the elements of the point cloud decoder of FIG. 11.

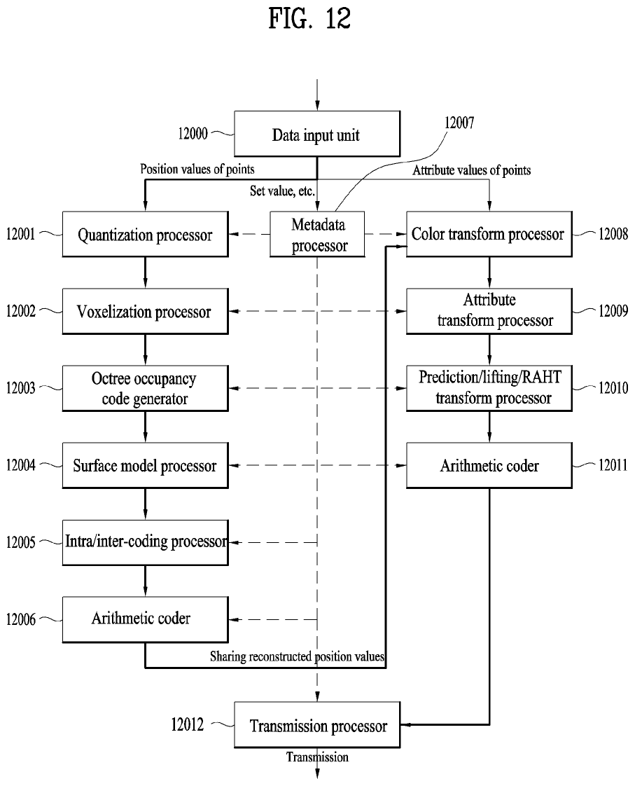

FIG. 12 illustrates a transmission device according to embodiments.

The transmission device shown in FIG. 12 is an example of the transmission device 10000 of FIG. 1 (or the point cloud encoder of FIG. 4). The transmission device illustrated in FIG. 12 may perform one or more of the operations and methods the same as or similar to those of the point cloud encoder described with reference to FIGS. 1 to 9. The transmission device according to the embodiments may include a data input unit 12000, a quantization processor 12001, a voxelization processor 12002, an octree occupancy code generator 12003, a surface model processor 12004, an intra/inter-coding processor 12005, an arithmetic coder 12006, a metadata processor 12007, a color transform processor 12008, an attribute transform processor 12009, a prediction/lifting/RAHT transform processor 12010, an arithmetic coder 12011 and/or a transmission processor 12012.

The data input unit 12000 according to the embodiments receives or acquires point cloud data. The data input unit 12000 may perform an operation and/or acquisition method the same as or similar to the operation and/or acquisition method of the point cloud video acquirer 10001 (or the acquisition process 20000 described with reference to FIG. 2).

The data input unit 12000, the quantization processor 12001, the voxelization processor 12002, the octree occupancy code generator 12003, the surface model processor 12004, the intra/inter-coding processor 12005, and the arithmetic coder 12006 perform geometry encoding. The geometry encoding according to the embodiments is the same as or similar to the geometry encoding described with reference to FIGS. 1 to 9, and thus a detailed description thereof is omitted.

The quantization processor 12001 according to the embodiments quantizes geometry (e.g., position values of points). The operation and/or quantization of the quantization processor 12001 is the same as or similar to the operation and/or quantization of the quantizer 40001 described with reference to FIG. 4. Details are the same as those described with reference to FIGS. 1 to 9.

The voxelization processor 12002 according to the embodiments voxelizes the quantized position values of the points. The voxelization processor 12002 may perform an operation and/or process the same or similar to the operation and/or the voxelization process of the quantizer 40001 described with reference to FIG. 4. Details are the same as those described with reference to FIGS. 1 to 9.

The octree occupancy code generator 12003 according to the embodiments performs octree coding on the voxelized positions of the points based on an octree structure. The octree occupancy code generator 12003 may generate an occupancy code. The octree occupancy code generator 12003 may perform an operation and/or method the same as or similar to the operation and/or method of the point cloud encoder (or the octree analyzer 40002) described with reference to FIGS. 4 and 6. Details are the same as those described with reference to FIGS. 1 to 9.

The surface model processor 12004 according to the embodiments may perform trigsoup geometry encoding based on a surface model to reconstruct the positions of points in a specific region (or node) on a voxel basis. The surface model processor 12004 may perform an operation and/or method the same as or similar to the operation and/or method of the point cloud encoder (for example, the surface approximation analyzer 40003) described with reference to FIG. 4. Details are the same as those described with reference to FIGS. 1 to 9.

The intra/inter-coding processor 12005 according to the embodiments may perform intra/inter-coding on point cloud data. The intra/inter-coding processor 12005 may perform coding the same as or similar to the intra/inter-coding described with reference to FIG. 7. Details are the same as those described with reference to FIG. 7. According to embodiments, the intra/inter-coding processor 12005 may be included in the arithmetic coder 12006.

The arithmetic coder 12006 according to the embodiments performs entropy encoding on an octree of the point cloud data and/or an approximated octree. For example, the encoding scheme includes arithmetic encoding. The arithmetic coder 12006 performs an operation and/or method the same as or similar to the operation and/or method of the arithmetic encoder 40004.

The metadata processor 12007 according to the embodiments processes metadata about the point cloud data, for example, a set value, and provides the same to a necessary processing process such as geometry encoding and/or attribute encoding. Also, the metadata processor 12007 according to the embodiments may generate and/or process signaling information related to the geometry encoding and/or the attribute encoding. The signaling information according to the embodiments may be encoded separately from the geometry encoding and/or the attribute encoding. The signaling information according to the embodiments may be interleaved.

The color transform processor 12008, the attribute transform processor 12009, the prediction/lifting/RAHT transform processor 12010, and the arithmetic coder 12011 perform the attribute encoding. The attribute encoding according to the embodiments is the same as or similar to the attribute encoding described with reference to FIGS. 1 to 9, and thus a detailed description thereof is omitted.

The color transform processor 12008 according to the embodiments performs color transform coding to transform color values included in attributes. The color transform processor 12008 may perform color transform coding based on the reconstructed geometry. The reconstructed geometry is the same as described with reference to FIGS. 1 to 9. Also, it performs an operation and/or method the same as or similar to the operation and/or method of the color transformer 40006 described with reference to FIG. 4 is performed. The detailed description thereof is omitted.

The attribute transform processor 12009 according to the embodiments performs attribute transformation to transform the attributes based on the reconstructed geometry and/or the positions on which geometry encoding is not performed. The attribute transform processor 12009 performs an operation and/or method the same as or similar to the operation and/or method of the attribute transformer 40007 described with reference to FIG. 4. The detailed description thereof is omitted. The prediction/lifting/RAHT transform processor 12010 according to the embodiments may code the transformed attributes by any one or a combination of RAHT coding, prediction transform coding, and lifting transform coding. The prediction/lifting/RAHT transform processor 12010 performs at least one of the operations the same as or similar to the operations of the RAHT transformer 40008, the LOD generator 40009, and the lifting transformer 40010 described with reference to FIG. 4. In addition, the prediction transform coding, the lifting transform coding, and the RAHT transform coding are the same as those described with reference to FIGS. 1 to 9, and thus a detailed description thereof is omitted.

The arithmetic coder 12011 according to the embodiments may encode the coded attributes based on the arithmetic coding. The arithmetic coder 12011 performs an operation and/or method the same as or similar to the operation and/or method of the arithmetic encoder 400012.

The transmission processor 12012 according to the embodiments may transmit each bitstream containing encoded geometry and/or encoded attributes and metadata information, or transmit one bitstream configured with the encoded geometry and/or the encoded attributes and the metadata information. When the encoded geometry and/or the encoded attributes and the metadata information according to the embodiments are configured into one bitstream, the bitstream may include one or more sub-bitstreams. The bitstream according to the embodiments may contain signaling information including a sequence parameter set (SPS) for signaling of a sequence level, a geometry parameter set (GPS) for signaling of geometry information coding, an attribute parameter set (APS) for signaling of attribute information coding, and a tile parameter set (TPS) for signaling of a tile level, and slice data. The slice data may include information about one or more slices. One slice according to embodiments may include one geometry bitstream Geom0⁰ and one or more attribute bitstreams Attr0⁰ and Attr®.

A slice refers to a series of syntax elements representing the entirety or part of a coded point cloud frame.

The TPS according to the embodiments may include information about each tile (for example, coordinate information and height/size information about a bounding box) for one or more tiles. The geometry bitstream may contain a header and a payload. The header of the geometry bitstream according to the embodiments may contain a parameter set identifier (geom_parameter_set_id), a tile identifier (geom_tile_id) and a slice identifier (geom_slice_id) included in the GPS, and information about the data contained in the payload.

As described above, the metadata processor 12007 according to the embodiments may generate and/or process the signaling information and transmit the same to the transmission processor 12012. According to embodiments, the elements to perform geometry encoding and the elements to perform attribute encoding may share data/information with each other as indicated by dotted lines. The transmission processor 12012 according to the embodiments may perform an operation and/or transmission method the same as or similar to the operation and/or transmission method of the transmitter 10003. Details are the same as those described with reference to FIGS. 1 and 2, and thus a description thereof is omitted.

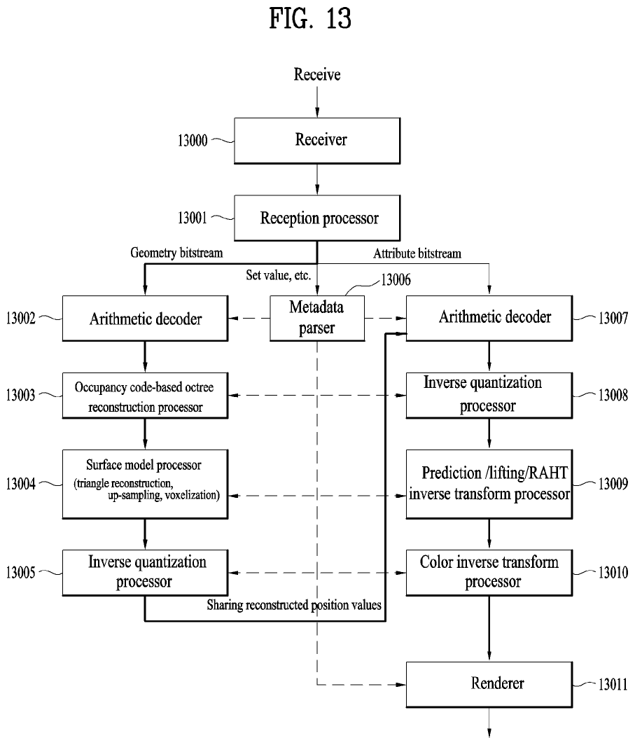

FIG. 13 illustrates a reception device according to embodiments.

The reception device illustrated in FIG. 13 is an example of the reception device 10004 of FIG. 1 (or the point cloud decoder of FIGS. 10 and 11). The reception device illustrated in FIG. 13 may perform one or more of the operations and methods the same as or similar to those of the point cloud decoder described with reference to FIGS. 1 to 11.

The reception device according to the embodiment includes a receiver 13000, a reception processor 13001, an arithmetic decoder 13002, an occupancy code-based octree reconstruction processor 13003, a surface model processor (triangle reconstruction, up-sampling, voxelization) 13004, an inverse quantization processor 13005, a metadata parser 13006, an arithmetic decoder 13007, an inverse quantization processor 13008, a prediction/lifting/RAHT inverse transform processor 13009, a color inverse transform processor 13010, and/or a renderer 13011. Each element for decoding according to the embodiments may perform an inverse process of the operation of a corresponding element for encoding according to the embodiments.

The receiver 13000 according to the embodiments receives point cloud data. The receiver 13000 may perform an operation and/or reception method the same as or similar to the operation and/or reception method of the receiver 10005 of FIG. 1. The detailed description thereof is omitted.

The reception processor 13001 according to the embodiments may acquire a geometry bitstream and/or an attribute bitstream from the received data. The reception processor 13001 may be included in the receiver 13000.

The arithmetic decoder 13002, the occupancy code-based octree reconstruction processor 13003, the surface model processor 13004, and the inverse quantization processor 13005 may perform geometry decoding. The geometry decoding according to embodiments is the same as or similar to the geometry decoding described with reference to FIGS. 1 to 10, and thus a detailed description thereof is omitted.

The arithmetic decoder 13002 according to the embodiments may decode the geometry bitstream based on arithmetic coding. The arithmetic decoder 13002 performs an operation and/or coding the same as or similar to the operation and/or coding of the arithmetic decoder 11000.

The occupancy code-based octree reconstruction processor 13003 according to the embodiments may reconstruct an octree by acquiring an occupancy code from the decoded geometry bitstream (or information about the geometry secured as a result of decoding). The occupancy code-based octree reconstruction processor 13003 performs an operation and/or method the same as or similar to the operation and/or octree generation method of the octree synthesizer 11001. When the trisoup geometry encoding is applied, the surface model processor 13004 according to the embodiments may perform trisoup geometry decoding and related geometry reconstruction (for example, triangle reconstruction, up-sampling, voxelization) based on the surface model method. The surface model processor 13004 performs an operation the same as or similar to that of the surface approximation synthesizer 11002 and/or the geometry reconstructor 11003.

The inverse quantization processor 13005 according to the embodiments may inversely quantize the decoded geometry.

The metadata parser 13006 according to the embodiments may parse metadata contained in the received point cloud data, for example, a set value. The metadata parser 13006 may pass the metadata to geometry decoding and/or attribute decoding. The metadata is the same as that described with reference to FIG. 12, and thus a detailed description thereof is omitted.

The arithmetic decoder 13007, the inverse quantization processor 13008, the prediction/lifting/RAHT inverse transform processor 13009 and the color inverse transform processor 13010 perform attribute decoding. The attribute decoding is the same as or similar to the attribute decoding described with reference to FIGS. 1 to 10, and thus a detailed description thereof is omitted.

The arithmetic decoder 13007 according to the embodiments may decode the attribute bitstream by arithmetic coding. The arithmetic decoder 13007 may decode the attribute bitstream based on the reconstructed geometry. The arithmetic decoder 13007 performs an operation and/or coding the same as or similar to the operation and/or coding of the arithmetic decoder 11005.

The inverse quantization processor 13008 according to the embodiments may inversely quantize the decoded attribute bitstream. The inverse quantization processor 13008 performs an operation and/or method the same as or similar to the operation and/or inverse quantization method of the inverse quantizer 11006.

The prediction/lifting/RAHT inverse transformer 13009 according to the embodiments may process the reconstructed geometry and the inversely quantized attributes. The prediction/lifting/RAHT inverse transform processor 13009 performs one or more of operations and/or decoding the same as or similar to the operations and/or decoding of the RAHT transformer 11007, the LOD generator 11008, and/or the inverse lifter 11009. The color inverse transform processor 13010 according to the embodiments performs inverse transform coding to inversely transform color values (or textures) included in the decoded attributes. The color inverse transform processor 13010 performs an operation and/or inverse transform coding the same as or similar to the operation and/or inverse transform coding of the color inverse transformer 11010. The renderer 13011 according to the embodiments may render the point cloud data.

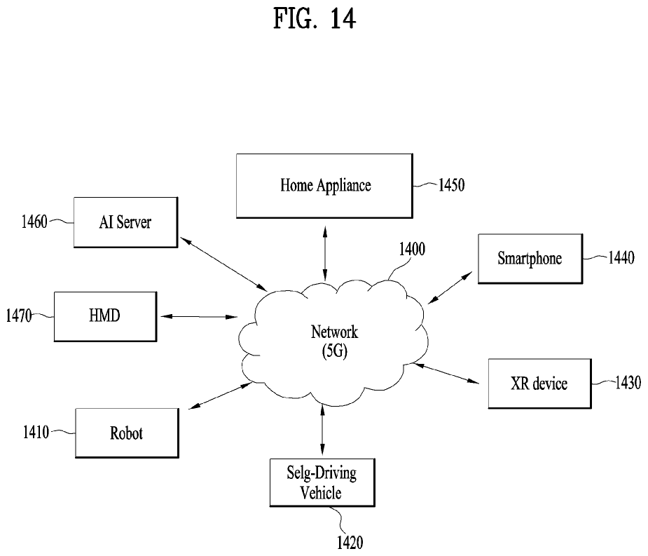

FIG. 14 illustrates an exemplary structure operable in connection with point cloud data transmission/reception methods/devices according to embodiments.

The structure of FIG. 14 represents a configuration in which at least one of a server 1460, a robot 1410, a self-driving vehicle 1420, an XR device 1430, a smartphone 1440, a home appliance 1450, and/or a head-mount display (HMD) 1470 is connected to the cloud network 1400. The robot 1410, the self-driving vehicle 1420, the XR device 1430, the smartphone 1440, or the home appliance 1450 is called a device. Further, the XR device 1430 may correspond to a point cloud data (PCC) device according to embodiments or may be operatively connected to the PCC device.

The cloud network 1400 may represent a network that constitutes part of the cloud computing infrastructure or is present in the cloud computing infrastructure. Here, the cloud network 1400 may be configured using a 3G network, 4G or Long Term Evolution (LTE) network, or a 5G network.

The server 1460 may be connected to at least one of the robot 1410, the self-driving vehicle 1420, the XR device 1430, the smartphone 1440, the home appliance 1450, and/or the HMD 1470 over the cloud network 1400 and may assist in at least a part of the processing of the connected devices 1410 to 1470.

The HMD 1470 represents one of the implementation types of the XR device and/or the PCC device according to the embodiments. The HMD type device according to the embodiments includes a communication unit, a control unit, a memory, an I/O unit, a sensor unit, and a power supply unit.

Hereinafter, various embodiments of the devices 1410 to 1450 to which the above-described technology is applied will be described. The devices 1410 to 1450 illustrated in FIG. 14 may be operatively connected/coupled to a point cloud data transmission device and reception according to the above-described embodiments.

<PCC+XR>

The XR/PCC device 1430 may employ PCC technology and/or XR (AR+VR) technology, and may be implemented as an HMD, a head-up display (HUD) provided in a vehicle, a television, a mobile phone, a smartphone, a computer, a wearable device, a home appliance, a digital signage, a vehicle, a stationary robot, or a mobile robot.

The XR/PCC device 1430 may analyze 3D point cloud data or image data acquired through various sensors or from an external device and generate position data and attribute data about 3D points. Thereby, the XR/PCC device 1430 may acquire information about the surrounding space or a real object, and render and output an XR object. For example, the XR/PCC device 1430 may match an XR object including auxiliary information about a recognized object with the recognized object and output the matched XR object.

<PCC+XR+Mobile Phone>

The XR/PCC device 1430 may be implemented as a mobile phone 1440 by applying PCC technology.

The mobile phone 1440 may decode and display point cloud content based on the PCC technology.

<PCC+Self-Driving+XR>

The self-driving vehicle 1420 may be implemented as a mobile robot, a vehicle, an unmanned aerial vehicle, or the like by applying the PCC technology and the XR technology.

The self-driving vehicle 1420 to which the XR/PCC technology is applied may represent a self-driving vehicle provided with means for providing an XR image, or a self-driving vehicle that is a target of control/interaction in the XR image. In particular, the self-driving vehicle 1420 which is a target of control/interaction in the XR image may be distinguished from the XR device 1430 and may be operatively connected thereto.

The self-driving vehicle 1420 having means for providing an XR/PCC image may acquire sensor information from sensors including a camera, and output the generated XR/PCC image based on the acquired sensor information. For example, the self-driving vehicle 1420 may have an HUD and output an XR/PCC image thereto, thereby providing an occupant with an XR/PCC object corresponding to a real object or an object present on the screen.

When the XR/PCC object is output to the HUD, at least a part of the XR/PCC object may be output to overlap the real object to which the occupant's eyes are directed. On the other hand, when the XR/PCC object is output on a display provided inside the self-driving vehicle, at least a part of the XR/PCC object may be output to overlap an object on the screen.

For example, the self-driving vehicle 1220 may output XR/PCC objects corresponding to objects such as a road, another vehicle, a traffic light, a traffic sign, a two-wheeled vehicle, a pedestrian, and a building.

The virtual reality (VR) technology, the augmented reality (AR) technology, the mixed reality (MR) technology and/or the point cloud compression (PCC) technology according to the embodiments are applicable to various devices.

In other words, the VR technology is a display technology that provides only CG images of real-world objects, backgrounds, and the like. On the other hand, the AR technology refers to a technology that shows a virtually created CG image on the image of a real object. The MR technology is similar to the AR technology described above in that virtual objects to be shown are mixed and combined with the real world. However, the MR technology differs from the AR technology in that the AR technology makes a clear distinction between a real object and a virtual object created as a CG image and uses virtual objects as complementary objects for real objects, whereas the MR technology treats virtual objects as objects having equivalent characteristics as real objects. More specifically, an example of MR technology applications is a hologram service.

Recently, the VR, AR, and MR technologies are sometimes referred to as extended reality (XR) technology rather than being clearly distinguished from each other. Accordingly, embodiments of the present disclosure are applicable to any of the VR, AR, MR, and XR technologies. The encoding/decoding based on PCC, V-PCC, and G-PCC techniques is applicable to such technologies.

The PCC method/device according to the embodiments may be applied to a vehicle that provides a self-driving service.

A vehicle that provides the self-driving service is connected to a PCC device for wired/wireless communication.

When the point cloud data (PCC) transmission/reception device according to the embodiments is connected to a vehicle for wired/wireless communication, the device may receive/process content data related to an AR/VR/PCC service, which may be provided together with the self-driving service, and transmit the same to the vehicle. In the case where the PCC transmission/reception device is mounted on a vehicle, the PCC transmission/reception device may receive/process content data related to the AR/VR/PCC service according to a user input signal input through a user interface device and provide the same to the user. The vehicle or the user interface device according to the embodiments may receive a user input signal. The user input signal according to the embodiments may include a signal indicating the self-driving service.

As described in FIGS. 1 to 14, point cloud data is composed of a set of points, and each point may have geometry information and attribute information. The geometry information is 3D location information (e.g., coordinate values of x, y, and z axes) of each point. That is, the position of each point is represented by parameters (e.g., parameters (x, y, z) of three axes representing space, X-axis, Y-axis, and Z-axis) on a coordinate system representing a three-dimensional space. The geometry information may be expressed as (r, θ, z) in a cylindrical coordinate system or (r, θ, Φ) in a spherical coordinate system depending on the coordinate system.

In addition, the attribute information may be a vector of values acquired by one or more sensors, such as point color (RGB, YUV, etc.), reflectance, normal vectors, transparency, brightness, and temperature values. The attribute information may be expressed in the form of scalar or vector.

According to embodiments, point cloud data may be classified into category 1 of static point cloud data, category 2 of dynamic point cloud data, and category 3 of dynamically acquired point cloud data according to the type and acquisition method of point cloud data. The category 1 consists of a point cloud of a single frame with a high density of points for an object or space. Category 3 data may be classified into frame-based data having a plurality of frames acquired while moving and fused data of a single frame in which a point cloud acquired through a lidar sensor for a large-scale space and a color image obtained as a 2D image are matched. For category 1 data, color may constitute attribute information, and for category 3 data, color, reflectance, and color+reflectance values may constitute attribute information according to the characteristics of content.

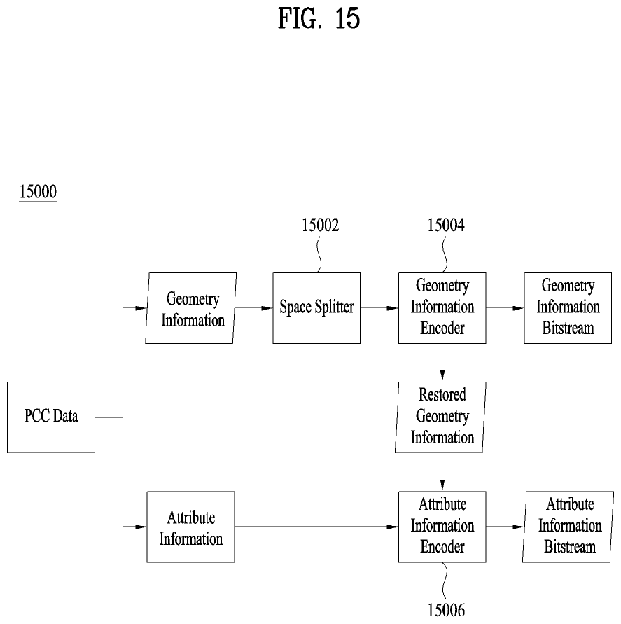

FIG. 15 is a block diagram illustrating an example of a point cloud encoder according to embodiments.

A point cloud encoder 15000 (for example, the point cloud encoder or transmission device described in FIGS. 1, 4, and 12) according to embodiments may perform the encoding operation described in FIGS. 1 to 14. The point cloud encoder 15000 according to embodiments may include a space splitter 15002, a geometry information encoder (or geometry encoder) 15004, and an attribute information encoder (or attribute encoder) 15006. The point cloud encoder 15000 according to embodiments is not shown in FIG. 15 but may further include one or more elements for performing the encoding operation described in FIGS. 1 to 14.

Point Cloud Compression (PCC) data (or PCC data, point cloud data) is input data of the point cloud encoder 15000, and may include geometry information and/or attribute information. The geometry information according to the embodiments is information indicating the position (for example, location) of a point, and may be expressed by parameters of a coordinate system such as a Cartesian coordinate system, a cylindrical coordinate system, and a spherical coordinate system. The attribute information according to embodiments is the attribute or attribute information described with reference to FIGS. 1 to 15, and is information indicating the attribute of each point. The attribute information may include any one or more of point color (e.g., RGB vector), a brightness value, a temperature value, and LiDAR reflection coefficients. Also, the attribute information may be acquired by one or more sensors.

The space splitter 15002 according to embodiments may split PCC data into one or more 3D blocks in a 3D space in order to store point information of the PCC data. A block according to embodiments may represent at least one of a tile group, a tile, a slice, a coding unit (CU), a prediction unit (PU), or a transformation unit (TU). The space splitter 15002 according to embodiments may perform a split operation based on at least one of an octree, a quad tree, a binary tree, a triple tree, or a k-d tree. In addition, the space splitter 15002 according to embodiments may split a space into blocks having predetermined width, length, and height. In addition, the space splitter 15002 may split a space by selectively determining various positions and sizes of blocks, entropy-encode the corresponding information, and transmit the same to a point cloud data receiver (or decoder) according to embodiments. In this case, one block may include one or more points.

The geometry information encoder 15004 (or geometry encoder) according to embodiments may encode geometry information to generate a geometry information bitstream and restored geometry information. Encoding may be performed in units of an entire point clouds or sub point clouds, or in coding units, and an inter prediction mode or an intra-screen prediction mode may be selected for each coding unit. Also, for encoding, an inter-prediction mode or an intra-prediction mode may be selected for each prediction unit. A bitstream generated through the geometry information encoder 15004 according to embodiments may be transmitted to a decoder according to embodiments.

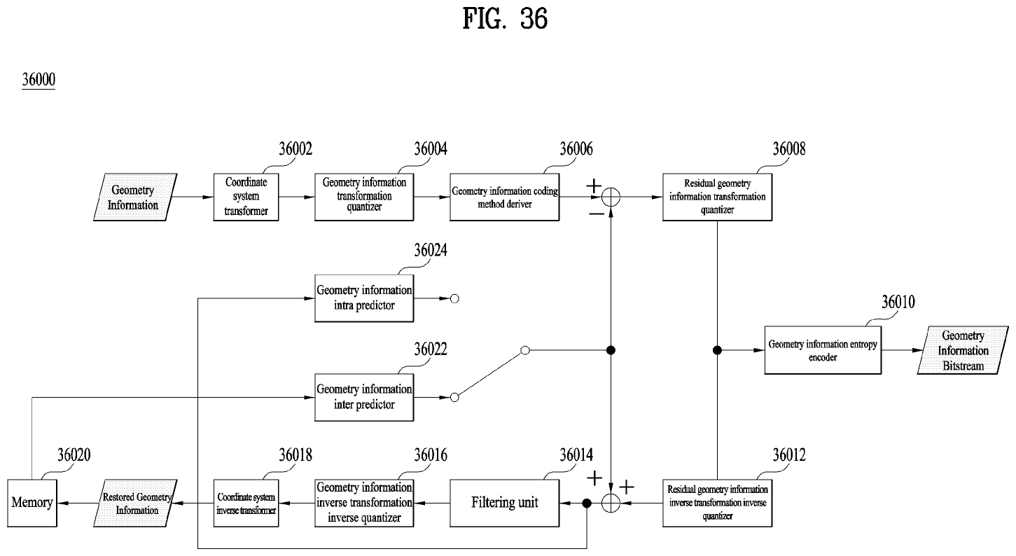

The geometry information encoder 15004 according to embodiments may perform operations of the coordinate system transformer (Transformation Coordinates) 40000, the quantizer (Quantize and remove points (voxelize)) 40001, the octree analyzer (Analyze octree) 40002, the surface approximation analyzer (Analyze surface approximation) 40003, the arithmetic encoder (Arithmetic encode) 40004, and the geometry reconstructor (Reconstruct geometry) 40005 described in FIG. 4. In addition, the geometry information encoder 15004 according to embodiments may perform operations of the data input unit 12000, the quantization processor 12001, the voxelization processor 12002, the octree occupancy code generator 12003, the surface model processor 12004, the intra/inter-coding processor 12005, the arithmetic coder 12006, the metadata processor 12007, the color transform processor 12008, the attribute transform processor 12009, the prediction/lifting/RAHT transform processor 12010, and the arithmetic coder 12011. Also, the geometry information encoder 15004 may correspond to a geometry information encoder 36000 of FIG. 36.

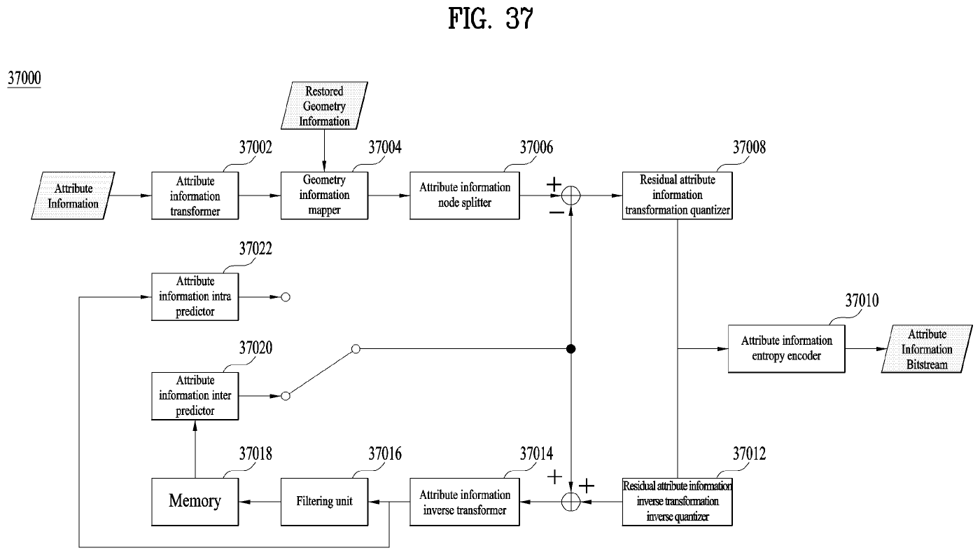

The restored geometry information may be input to the attribute information encoder 15006. The attribute information encoder 15006 according to embodiments may generate an attribute information bitstream based on the restored geometry information. The generated geometry information bitstream and attribute information bitstream may be compressed into bitstreams and transmitted to a point cloud data receiver (or decoder) according to embodiments. The compressed bitstream may include signaling information related to the geometry information bitstream and the attribute information bitstream. The attribute information encoder 15006 may correspond to an attribute information encoder 37000 of FIG. 37.

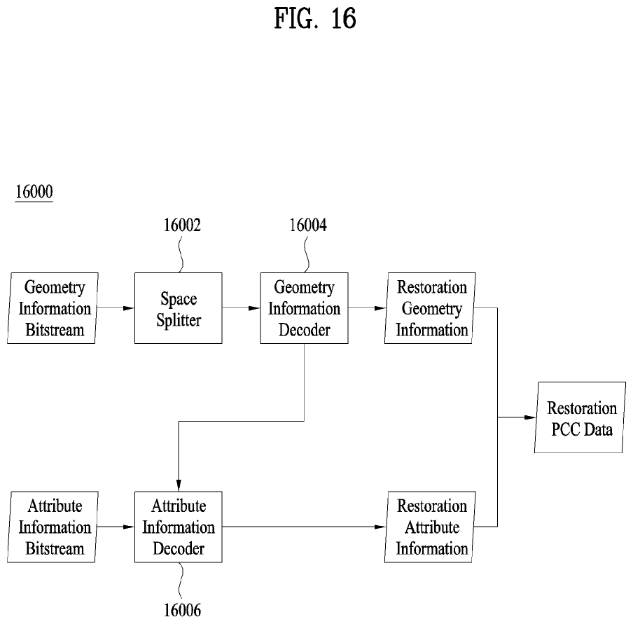

FIG. 16 is a block diagram illustrating an example of a point cloud decoder according to embodiments.

A point cloud decoder 16000 (for example, the point cloud decoder or receiver described in FIGS. 1, 10, 11, and 13) according to embodiments may perform the decoding operation described in FIGS. 1 to 14. In addition, the point cloud decoder 16000 may perform a decoding operation corresponding to a reverse process of an encoding operation of the point cloud encoder 15000 described in FIG. 15. The point cloud decoder 16000 according to embodiments may include a space splitter 16002, a geometry information decoder 16004 (or geometry decoder), and an attribute information decoder (or attribute information decoder or attribute decoder) 16006. Although not shown in FIG. 16, the point cloud decoder 16000 according to embodiments may further include one or more elements for performing the decoding operation described in FIGS. 1 to 14.

The space splitter 16002 according to embodiments may split a space based on signaling information (e.g., information on a split operation performed by the space splitter 15002 described in FIG. 15 or split information of a subcloud determined by an encoder and/or an encoding/decoding unit (CU), a prediction unit (PU), or a transformation unit (TU)) received from a point cloud data transmission device (e.g., the point cloud encoder or transmission device described in FIGS. 1, 4, 12, and 15) according to embodiments or split information derived (generated) by the point cloud decoder 16000. The encoding/decoding unit (CU), the prediction unit (PU), or the transformation unit (TU) may have the same partition structure or different partition structures according to embodiments. The split operation of the space splitter 16002 of the point cloud decoder 16000 may be based on at least one of an octree, a quad tree, a binary tree, a triple tree, or a k-d tree.

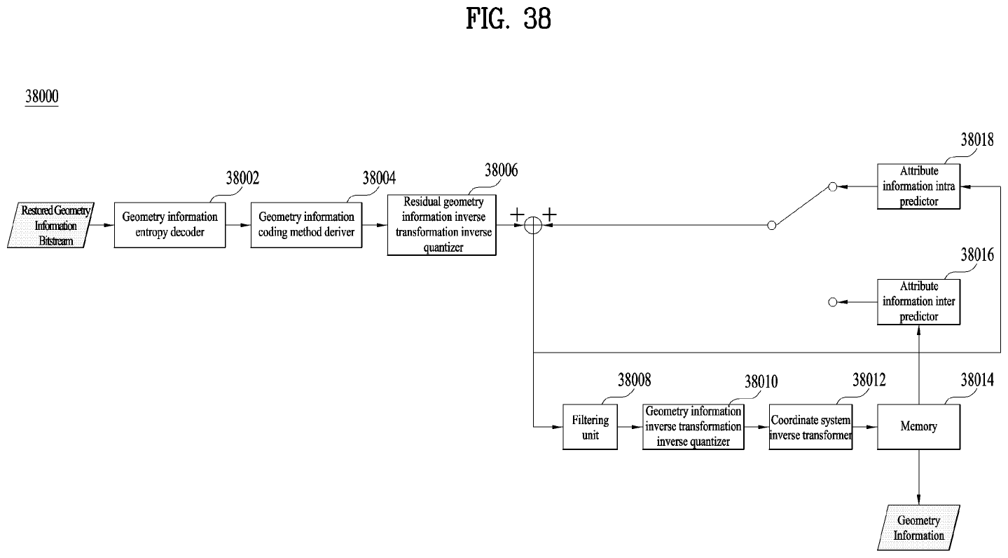

The geometry information decoder 16004 according to embodiments may decode an input geometry information bitstream to restore geometry information. The restored geometry information may be input to an attribute information decoder 16006. The geometry information decoder 16004 according to embodiments may perform operations of the arithmetic decoder (Arithmetic decode) 11000, the octree synthesizer (Synthesize octree) 11001, the surface approximation synthesizer (Synthesize surface approximation) 11002, the geometry reconstructor (Reconstruct geometry) 11003, and the coordinate inverse transformer (Inverse transform coordinates) 11004 described with reference to FIG. 11). In addition, the geometry information decoder 16004 according to embodiments may perform operations of the arithmetic decoder 13002, the occupancy code-based octree reconstruction processor 13003, the surface model processor (triangle reconstruction up-sampling, voxelization) 13004, and the inverse quantization processor 13005 described with reference to FIG. 13. The geometry information decoder 16004 may correspond to a geometry information decoder 38000 of FIG. 38.

The geometry information decoder 16004 according to embodiments may perform decode with the entire cloud, subcloud, or encoding/decoding unit, and may receive a flag to determine whether the current prediction is intra prediction or inter prediction for each encoding/decoding unit. In addition, prediction may be performed by receiving mode information of inter prediction or intra prediction for each prediction unit.

The attribute information decoder 16006 according to embodiments may restore attribute information based on an attribute information bitstream and restored geometry information. The attribute information decoder 16006 may perform decoding with the entire cloud, subcloud, or encoding/decoding unit, and may receive a flag to determine whether the current prediction is intra prediction or inter prediction for each encoding/decoding unit. In addition, prediction may be performed by receiving mode information of inter prediction or intra prediction for each prediction unit. The attribute information decoder 16006 may be omitted in some embodiments. The point cloud decoder 16000 may output restored PCC data based on restored geometry information and restored attribute information.

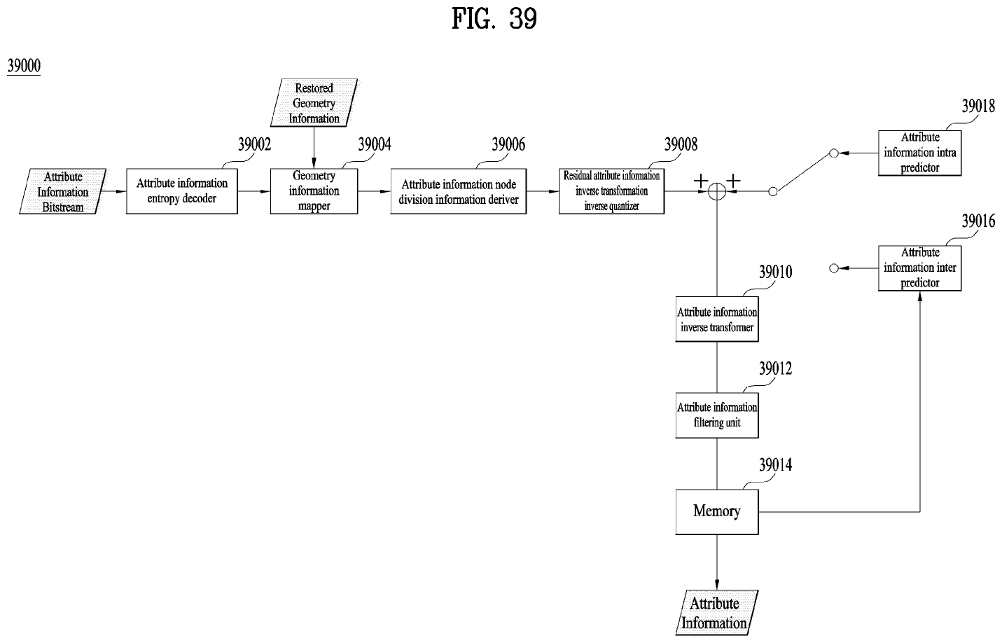

The attribute information decoder 16006 according to embodiments may decode an input attribute bitstream to restore attribute information. The restored geometry information may be input to the attribute information decoder 16006. The attribute information decoder 16006 according to embodiments may perform operations of the arithmetic decoder (arithmetic decode) 11005, the inverse quantizer (Inverse quantize) 11006, the RAHT transformer 11007, the LOD generator (Generate LOD) 11008, the inverse lifter 11009, and the color inverse transformer (Inverse transform colors) 11010 described in FIG. 11. In addition, the attribute information decoder 16006 according to embodiments may perform operations of the arithmetic decoder 13007, the inverse quantization processor 13008, the prediction/lifting/RAHT inverse transform processor 13009, and the color inverse transform processor 13010 described in FIG. 13. Also, the attribute information decoder 16006 may correspond to an attribute information decoder 39000 of FIG. 39.

For the above-mentioned point cloud data encoding or decode, it may be possible to increase accuracy and coding efficiency by selecting a residual with high relevance from residuals calculated based on a prediction point, defining a quantization unit, and quantizing a corresponding residual coding unit. Point prediction may be performed based on a best motion vector used in inter prediction.

A point cloud data transmitter or receiver according to embodiments may perform quantization on residual information of geometry information or attribute information of point cloud data in a specific unit. In addition, an apparatus for transmitting or receiving point cloud data according to embodiments may perform quantization based on an offset or difference value of a base quantization parameter of a large group unit of a node, such as a quantization performance unit, a slice, or a tile, and a quantization parameter of a small group unit of a node in a quantization process during encoding or decoding. It may be advantageous that the quantization parameter in small group units is transmitted as an offset or difference value with respect to the base quantization parameter in large group units.

A point cloud data transmission device or reception device according to embodiments may define a residual geometry information unit and process residual information based on the characteristics of the geometry information. As a residual geometry information unit, residual information located inside and outside the residual geometry information unit may be deleted or included according to specific standards. The point cloud data transmission device or a reception device according to embodiments may perform entropy transformation and quantization in units of residual geometry information, and may select and transform transformation types by integrating residual geometry information in units of transformation units. That is, the residuals calculated in the residual geometry information unit may be integrated again and then transformed in units of the transformation unit (a unit equal to or larger than the residual geometry information unit). In addition, the point cloud data transmission device or reception device according to embodiments may generate a quantization unit by integrating a transformation unit. By integrating the transformation unit, the number of quantization parameters to be transmitted to the decoder may be reduced.

Hereinafter, a process of generating residual geometry information in a point cloud data processing method according to embodiments will be described. The point cloud data processing method according to embodiments may refer to a method of encoding or decoding point cloud data in the point cloud data transmission device or reception device according to embodiments.

Residual geometry information may be generated in several methods, and residual geometry information may be generated in a node prediction mode, a direct coding mode, and a node segmentation mode according to the point cloud data processing method according to the embodiments.

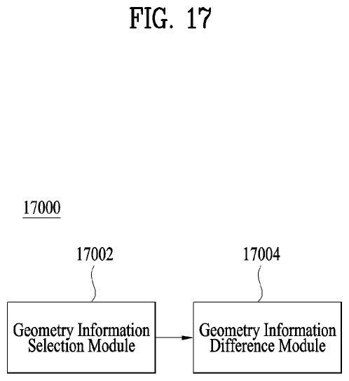

FIG. 17 illustrates a process of generating residual geometry information of a point cloud data transmission device according to embodiments. The point cloud data transmission device (for example, the point cloud encoder or transmission device described in FIGS. 1, 4, 12, 15, 36, and 37) according to embodiments includes a residual geometry information generator 17000. In addition, the residual geometry information generator 17000 may include a geometry information selection module 17002 and a geometry information difference module 17004.

In the node prediction mode, residual geometry information may be generated by differentiating predictive geometry information and original geometry information. The predictive geometry information may be generated by a geometry information inter predictor 36022 (in FIG. 36) or a geometry information intra predictor 36024 (in FIG. 36). The original geometry information may mean original geometry information of point cloud data according to embodiments. The predictive geometry information may refer to geometry information predicted through an intra prediction or inter prediction method. Intra prediction may mean prediction using data corresponding to the same frame, and inter prediction may mean prediction using a motion vector based on data corresponding to different frames.

The geometry information selection module 17002 may select geometry information in a prediction node. The geometry information may be deleted and selected in a geometry information selection unit. The geometry information selection unit may have a size of 1×1×1 or more, and information for splitting the size or prediction node of the geometry information selection unit into the geometry information selection unit may be generated and transmitted to the point cloud data reception device according to embodiments.

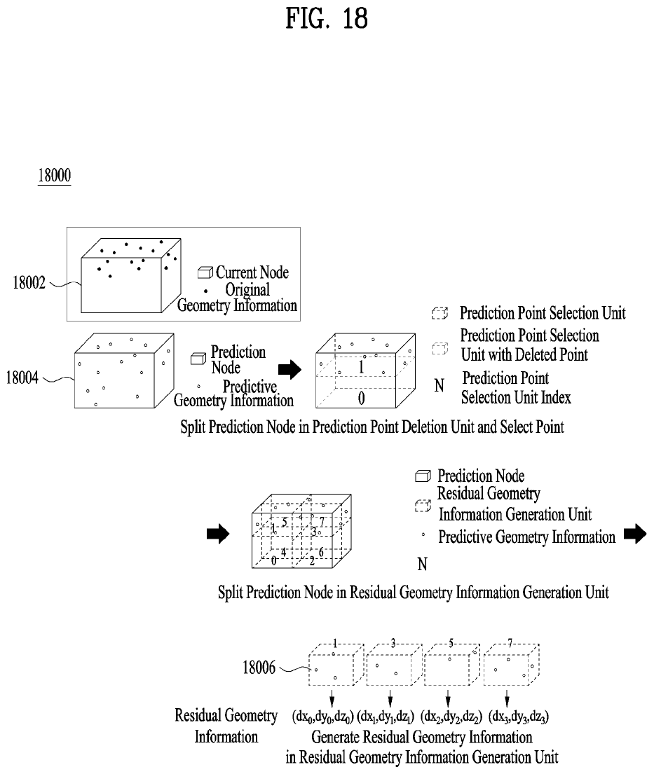

FIG. 18 illustrates a process of selecting geometry information of a point cloud data transmission device according to embodiments. If a distance between representative geometry information of a geometry information selection unit and representative geometry information of n pieces of original geometry information close thereto is greater than a certain threshold, all geometry information within the corresponding geometry information selection unit may be deleted. The original representative geometry information may be designated as a median, a mean, or a mode of the original geometry information of a current node 18002, and a prediction node 18004 may select points that do not exceed a threshold based on the original representative geometry information. The threshold may be specified as a predetermined value. An index of the geometry information selection unit deleted in the selection process may be transmitted to a point cloud data reception device according to embodiments. That is, information on deletion of predictive geometry information may be transmitted to a point cloud data reception device according to embodiments.

FIG. 18 shows original geometry information of the current node 18002 and predictive geometry information of the prediction node 18004. In this case, the prediction node 18004 may be classified as a geometry information selection unit (or prediction point selection unit), and an index may be designated for each geometry information selection unit. Therefore, the predictive geometry information (or prediction point) of the prediction node 18004 may be deleted by the geometry information selection unit. That is, as shown in FIG. 18, predictive geometry information of a geometry information selection unit having an index of 0 may be deleted. Regarding which predictive geometry information belonging to a geometry information selection unit is to be deleted, the predictive geometry information to be deleted may be determined based on a distance between the predictive geometry information and the original geometry information. A geometry information selection unit to delete predictive geometry information may be determined based on a distance between representative values of the predictive geometry information and the original geometry information.

Then, residual geometry information may be generated for predictive geometry information not deleted in the prediction node 18004. At this time, the prediction node 18004 may be split into residual geometry information generation units, and an index may be designated for each residual geometry information generation unit.

The geometry information difference module 17004 may generate residual geometry information for each residual geometry information generation unit in which geometry information exists. Residual geometry information for each residual geometry information generation unit may be generated to minimize a difference between predictive geometry information and representative geometry information of m pieces of original geometry information close to the predictive geometry information. The residual geometry information may include a residual representative offset for each residual geometry information generation unit to minimize a difference between the representative geometry information of the original geometry information and the predictive geometry information, and may include a residual offset for each point for each predictive geometry information. One residual geometry information may be composed of x, y, and z-axis values. As seen from FIG. 18, residual geometry information may be generated for residual geometry information generation units having indices of 1, 3, 5, and 7.

The operations of the geometry information selection module 17002 and the geometry information difference module 17004 may be selectively performed or the order in which they are performed may be changed. The residual geometry information generator 17000, the geometry information selection module 17002, and the geometry information difference module 17004 may correspond to hardware, software, processors, and/or combinations thereof.

The point cloud data transmission device according to embodiments may reduce the size of bits transmitted to the point cloud data reception device according to embodiments and increase encoding/decode efficiency by generating residual geometry information. Generation of residual geometry information may be supported in the process of compressing or restoring point cloud data used in inter prediction or intra prediction. In addition, the point cloud data transmission device according to the embodiments may reduce a bitstream and further increase compression and restoration efficiency of point cloud data through selection of geometry information and generation of residual geometry information based on a residual geometry information generation unit. It may be difficult to select predictive geometry information in the case of point cloud data in a form in which geometry information is very dense and full, whereas point cloud data in a form in which geometry information is not dense may obtain improved compression performance through prediction and selection of predictive geometry information.

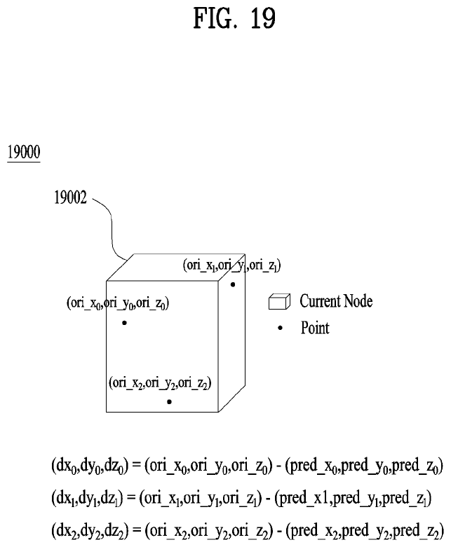

FIG. 19 illustrates a process of generating residual geometry information of a point cloud data transmission device according to embodiments. More specifically, the drawing shows a process of generating residual geometry information in the case of a direct coding mode of point cloud data according to the embodiments.

Referring to FIG. 19, the point cloud data transmission device according to embodiments may generate residual geometry information by differentiating predictive geometry information from original geometry information in a current node 19002. The point direct coding mode is a mode for transmitting original geometry information of a point or residual geometry information for one or more points in the current node 19002. The inter predictor 36022 (in FIG. 36) or the intra predictor 36024 (in FIG. 36) according to embodiments may generate predictive geometry information for original geometry information in the current node 19002, and the geometry information difference module 17004 according to embodiments may generate point-based residual geometry information by differentiating original geometry information and predictive geometry information. The point cloud data transmission device according to embodiments may generate residual geometry information by differentiating predictive geometry information from original geometry information, thereby reducing the size of bits transmitted to the point cloud data reception device according to embodiments, and increasing encoding/decoding efficiency.

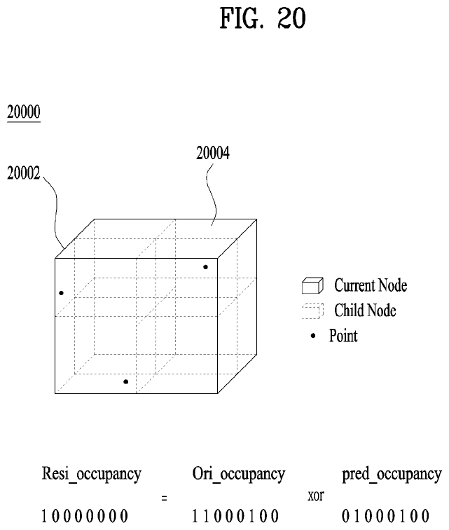

FIG. 20 illustrates a process of generating residual geometry information of a point cloud data transmission device according to embodiments. More specifically, the drawing shows a process of generating residual geometry information in the case of a node split mode of point cloud data according to the embodiments. The residual geometry information may include residual occupancy information.

The point cloud data transmission device may generate residual occupancy based on occupancy information of a child node 20004 generated by splitting a current node 20002. The occupancy information is information expressed as 0 or 1 depending on whether a node includes point cloud data. The occupancy information may exist as many as the number of the child nodes 20004 generated according to a split mode of the current node 20002. For example, in the occupancy information, the child node 20004 that includes point cloud data may be expressed as 1, and the child node 20004 that does not include point cloud data may be expressed as 0. The original occupancy information is occupancy information calculated according to whether a node includes original geometry information, and predicted occupancy information is occupancy information calculated according to whether a node includes predictive geometry information. The inter predictor 36022 (in FIG. 36) or the intra predictor 36024 (in FIG. 36) according to embodiments may generate predictive occupancy information based on predictive geometry information. The residual occupancy information may be generated by differentiating original occupancy information and predicted occupancy information or performing a bit operation. The bit operation may include operations such as and, or, and xor.

FIG. 20 shows an example in which the current node 20002 is split into an octree structure to generate 8 child nodes 20004 and residual occupancy information is generated by xor-operating original occupancy information and predicted occupancy information. Information on calculation of original occupancy information and predicted occupancy information may be transmitted to a reception device according to embodiments.

A point cloud data transmission device according to embodiments may support various uses of residual geometry information by generating residual occupancy information based on original occupancy information and predicted occupancy information. In addition, the point cloud data transmission device according to embodiments may reduce the size of bits transmitted to the point cloud data reception device according to embodiments and increase encoding/decoding efficiency by generating residual occupancy information.

A point cloud data transmission device according to embodiments may transform residual geometry information or perform quantization on residual geometry information. More specifically, a residual geometry information transformation quantizer 36008 (in FIG. 36) according to embodiments may transform residual geometry information or perform quantization on the residual geometry information.

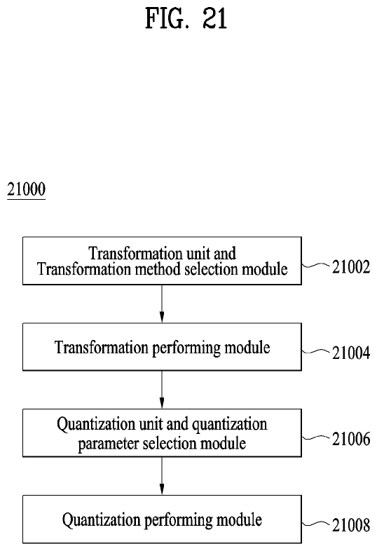

FIG. 21 shows an example of a process of transforming or quantizing residual geometry information of a point cloud data transmission device according to embodiments. The point cloud data transmission device according to embodiments may include a transformation unit and transformation method selection module 21002, a transformation performing module 21004, a quantization unit and quantization parameter selection module 21006, and/or a quantization performing module 21008, and output a quantization level unit. A transformation or quantization process of residual geometry information may be performed by each component, and an operation of each component may be omitted or the order thereof may be changed.

The transformation unit and transformation method selection module 21002 may select a transformation unit and transformation method of residual geometry information based on residual geometry information generated by a residual geometry information generator (refer to the description of FIG. 17) according to embodiments.

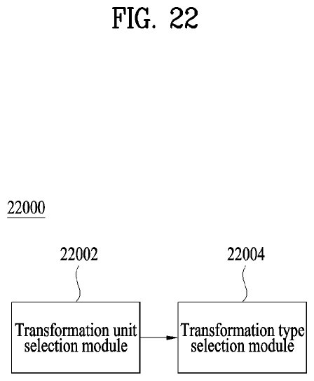

FIG. 22 illustrates an operation of the transformation unit and transformation method selection module 21002 according to embodiments. The transformation unit and transformation method selection module 21002 according to embodiments includes a transformation unit selection module 22002 and a transformation method selection module 22004.

The transformation unit selection module 22002 may receive n×d pieces of residual geometry information from a residual geometry information generator (in FIG. 17) according to embodiments. In this case, n may mean the number of residual geometry information, and d may mean the number of dimensions of the residual geometry information. The transformation unit selection module splits the current node into transformation subnodes and groups the residual geometry information included in each transformation subnode area to designate as a residual geometry information group. In this case, the transformation subnode may be shaped like a rectangular parallelepiped including at least one residual geometry information generating unit. As information on the transformation subnode, the number of residual geometry information generating units for each axis of the transformation subnode may be transmitted to a point cloud data reception device according to embodiments. Also, information on lengths or ratios splitting each axis of the current node may be transmitted to the point cloud data reception device according to embodiments. In addition, information on a method of splitting the current node using a tree structure (quad tree, binary tree, triple tree, octree, etc.) may be transmitted to the point cloud data reception device according to embodiments. The transformation unit selection module 22002 may generate a transformation unit by grouping residual values for one or multiple axes of the residual geometry information group and reconstructing them in m dimension.

The transformation method selection module 22004 may select a transformation method for each transformation unit generated in the transformation unit selection module and transmit information on the transformation method to the point cloud data reception device according to embodiments. Types of transformation methods may include DCT, DST, SADCT, RAHT, and the like.

In FIG. 21, the transformation performing module 21004 may perform transformation in units of transformation units determined in the transformation unit and transformation method selection module 21002 to generate a transformation coefficient unit.

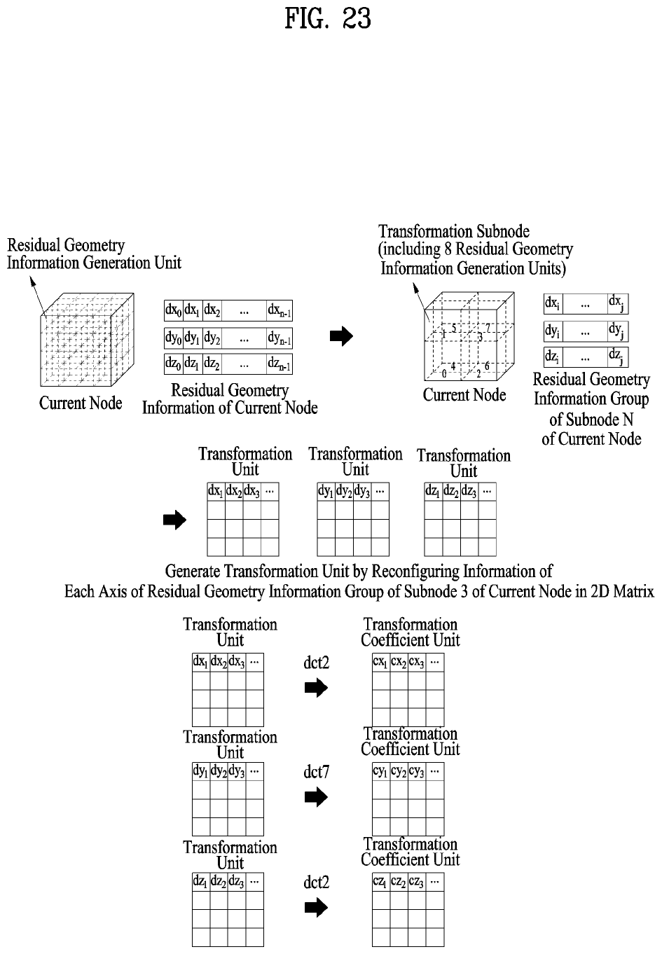

FIG. 23 shows an example of transforming residual geometry information of a point cloud data transmission device according to embodiments. The drawing shows a process in which at least one residual geometry information generation unit is grouped into one transformation subnode, and the residual geometry information grouped in transformation subnode units is DCT-transformed. In FIG. 23, the transformation subnode is composed of 8 residual geometry information generation units, and information on each axis in the grouped residual geometry information group is reconstructed into a two-dimensional matrix to generate a transformation unit. In addition, when the transformation unit, which is a two-dimensional matrix, is DCT-transformed, a transformation coefficient unit is generated.

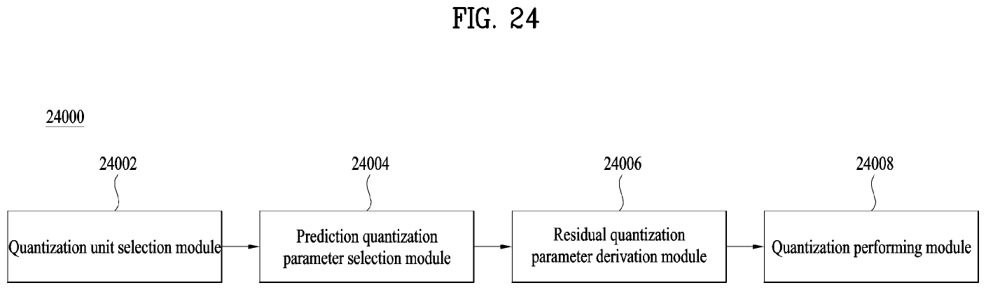

FIG. 24 shows an example of a quantization process of a point cloud data transmission device according to embodiments. A point cloud data transmission device according to embodiments may include a quantization unit selection module 24002, a prediction quantization parameter selection module 24004, a residual quantization parameter derivation module 24006, and/or a quantization performing module 24008.

The quantization unit selection module 24002 may generate a quantization unit by splitting the current node into quantization subnodes and grouping transformation units included in the quantization subnode area.

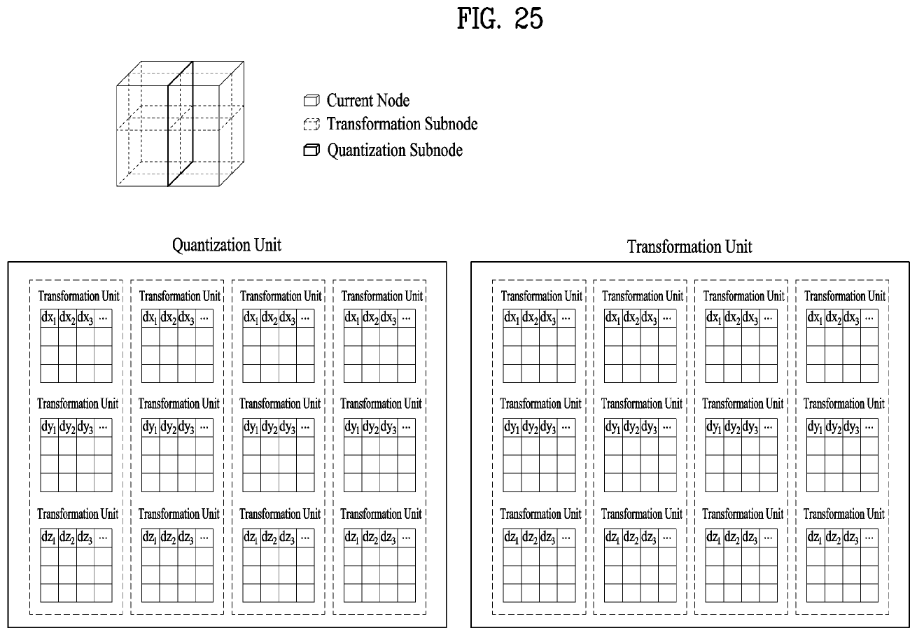

FIG. 25 illustrates an example of generating a quantization unit in the quantization unit selection module 24002 according to embodiments. The drawing shows Referring to FIG. 25, a quantization subnode may be a part or all of the current node area and may include one or more transformation subnodes. The quantization unit may be generated by grouping transformation units included in the quantization subnode area. The quantization unit selection module 24002 according to embodiments may generate a quantization unit by defining the size and position of the quantization unit.

When the quantization subnode includes one or more transformation subnodes, information on the length of each axis of the quantization subnode or the number of transformation subnodes for each axis, information on a split depth of each axis to split the current node into quantization subnodes, or information on a specific tree structure (octree, quad tree, binary tree, etc.) for splitting the current node into quantization subnodes may be transferred to the point cloud data reception device according to embodiments. That is, information on a method of splitting the current node into quantization subnodes may be transferred to the point cloud data reception device according to the embodiments.

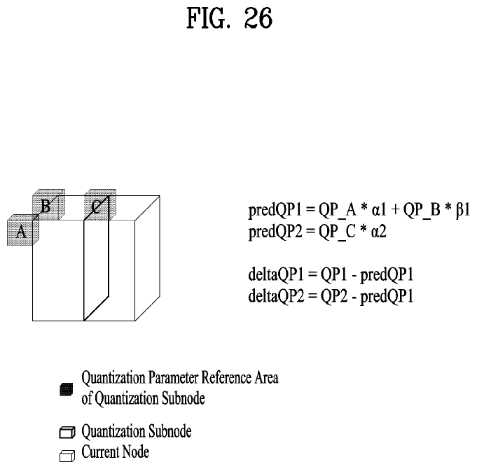

FIG. 26 is a diagram for explaining operations of the prediction quantization parameter selection module 24004 and the residual quantization parameter derivation module 24006 according to embodiments.

The prediction quantization parameter selection module 24004 may select a prediction quantization parameter for a corresponding quantization subnode based on a quantization parameter of a surrounding area determined by a quantization parameter selection unit. The prediction quantization parameter selection module 24004 may select a prediction quantization parameter in units of quantization subnodes. The prediction quantization parameter selection module 24004 may configure one or more prediction quantization parameter candidates as a list, select a prediction quantization parameter from the list, and transmit an index of the selected prediction quantization parameter. A prediction quantization parameter candidate for a specific quantization subnode may include a quantization parameter corresponding to a quantization subnode in the surrounding area. In addition, the prediction quantization parameter candidate may include a value derived by weighted summing quantization parameters of quantization subnodes in the surrounding area. That is, the prediction quantization parameter candidate may be configured based on the quantization parameter of the surrounding area. When there is no quantization subnode in the surrounding area to refer to the quantization parameter, the quantization parameter selected in units of slice, tile, frame, etc. may be used as a prediction quantization parameter candidate.

The residual quantization parameter derivation module 24006 may generate a residual quantization parameter by differentiating a quantization parameter and a prediction quantization parameter, and the residual quantization parameter may be transmitted to a point cloud data reception device according to embodiments.

In FIG. 26, predQP1 and predQP2 are prediction quantization parameters for the corresponding quantization subnode, and QP_A, QP_B, and QP_C are predetermined quantization parameters for the surrounding area of the corresponding quantization subnode. Also, deltaQP1 and deltaQP2 are residual quantization parameters. Referring to FIG. 26, a prediction quantization parameter may be generated based on a quantization parameter of a surrounding area of a corresponding quantization subnode, and a residual quantization parameter may be generated as a difference value between a quantization parameter and a prediction quantization parameter.

The quantization performing module 24008 may perform quantization using quantization parameters in units of quantization units and generate a quantization level.

A point cloud data transmission device according to embodiments may efficiently transmit information about a quantization parameter by generating a residual quantization parameter based on a quantization parameter and a prediction quantization parameter. That is, the point cloud data transmission device according to embodiments may reduce the size of bits transmitted to the point cloud data reception device according to embodiments and increase encoding/decode efficiency by generating a residual quantization parameter.

Hereinafter, restoration of residual geometric information in relation to a point cloud data processing method according to the embodiments will be described.

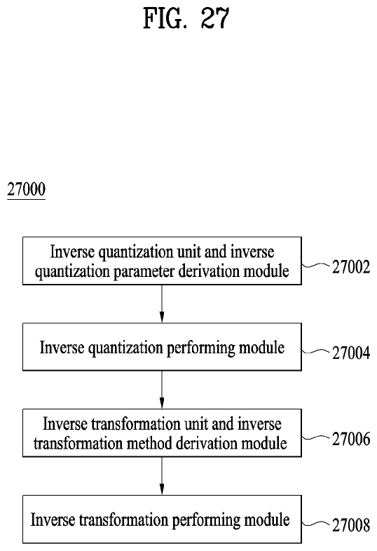

FIG. 27 shows an inverse quantization and inverse transformation process of point cloud data according to embodiments. A point cloud data reception device according to embodiments may include an inverse quantization unit and inverse quantization parameter derivation module 27002, an inverse quantization performing module 27004, an inverse transformation unit and inverse transformation method derivation module 27006, or an inverse transformation performing module 27008. In more detail, a residual geometry information inverse transformation inverse quantizer 38006 (in FIG. 38) may perform the process shown in FIG. 27.

In addition, a point cloud data transmission device according to embodiments may include the inverse quantization unit and inverse quantization parameter derivation module 27002, the inverse quantization performing module 27004, the inverse transformation unit and inverse transformation method derivation module 27006 or the inverse transformation performing module 27008. More specifically, the process shown in FIG. 27 may be performed in the residual geometry information inverse transformation inverse quantization unit 36012 (in FIG. 36). The point cloud data transmission device according to embodiments may perform inverse quantization or inverse transformation in a process of restoring geometry information for encoding attribute information.

When a coding mode of a point cloud data is a node prediction mode, a residual geometry information inverse transformation inverse quantizer (a residual geometry information inverse transformation inverse quantizer in FIGS. 36 and 38) according to the embodiments may generate restored residual geometry information by performing inverse transformation or inverse quantization on entropy decoded residual geometry information. The residual geometry information inverse transformation inverse quantizer (the residual geometry information inverse transformation inverse quantizer of FIGS. 36 and 38) according to embodiments may include the inverse quantization unit and inverse quantization parameter derivation module 27002, the inverse quantization performing module 27004, the inverse transformation unit and inverse transformation method derivation module 27006, the inverse transformation performing module 27008, a predictive geometry information generator, and a restoration geometry information generator. At this time, an operation of each component may be omitted or the order thereof may be changed.

The residual geometry information inverse transformation inverse quantizer (the residual geometry information inverse transformation inverse quantizer in FIGS. 36 and 38) according to embodiments may generate restoration residual geometry information by performing inverse quantization and inverse transformation and generate restoration geometry information by summing predictive geometry information and the restoration residual geometry information. Components according to embodiments may correspond to hardware, software, processors, and/or combinations thereof.

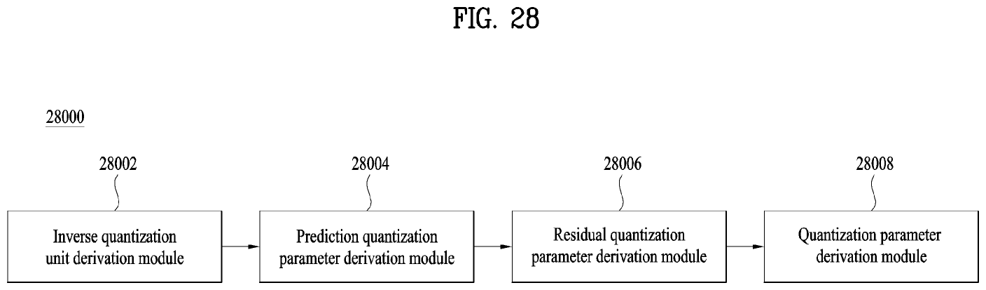

FIG. 28 illustrates an operation process of an inverse quantization unit and an inverse quantization parameter derivation module according to embodiments. The inverse quantization unit and inverse quantization parameter derivation module 27002 includes an inverse quantization unit derivation module 28002, a prediction quantization parameter derivation module 28004, a residual quantization parameter derivation module 28006, or a quantization parameter derivation module 28008.

The inverse quantization unit derivation module 28002 may derive a quantization unit by parsing information on a method of splitting the current node into quantization subnodes and a method of splitting a quantization subnode into quantization units. The inverse quantization unit derivation module 28002 may parse information on whether to split the current node and may or may not perform split. When performing split, a split type may be parsed. If a split type is a tree structure, a tree type may be parsed recursively, and if the split type is a lattice split, the inverse quantization subnode may be derived by parsing the number of splits and the split length for each axis. A quantized residual geometry information group included in the quantization subnode may be the inverse quantization unit, and inverse quantization may be performed in the inverse quantization unit. The inverse quantization subnode is virtually the same as the quantization subnode, and since the inverse quantization subnode is a subnode where an inverse quantization process is performed, it is expressed as an inverse quantization subnode to distinguish it from the quantization subnode.

The prediction quantization parameter derivation module 28004 may derive a prediction quantization parameter in units of quantization units. For each quantization unit, a prediction quantization parameter candidate list may be configured from one or more reference quantization parameters of a restored region adjacent to the prediction quantization parameter derivation unit. The prediction quantization parameter derivation module 28004 may select one or more prediction quantization parameters from the list based on the received prediction quantization parameter index, and weight-sum the selected prediction quantization parameters based on a distance from the inverse quantization subnode to derive a final prediction. quantization parameter. The referenceable region list of each quantization unit may be configured in the same way as the point cloud data transmission device according to the embodiments. When a referenceable region does not exist, a base quantization parameter transmitted in units of slices, tiles, pictures, etc. may be designated as the final prediction quantization parameter.

The residual quantization parameter derivation module 28006 may parse a residual quantization parameter in units of quantization units. The quantization parameter derivation module 28008 may generate a quantization parameter by adding a prediction quantization parameter and a residual quantization parameter.

The inverse quantization performing module 27004 of FIG. 27 may perform inverse quantization using the quantization parameter derived from the quantization parameter derivation module 28008 in units of quantization units, and generate conversion coefficients of the current node.

The inverse transformation unit and inverse transformation method derivation module 27006 of FIG. 27 may group the transformation coefficients of the residual geometry information output from the inverse quantization performing module 27004 into inverse transformation units, and derive the inverse transformation method of each inverse transformation unit.

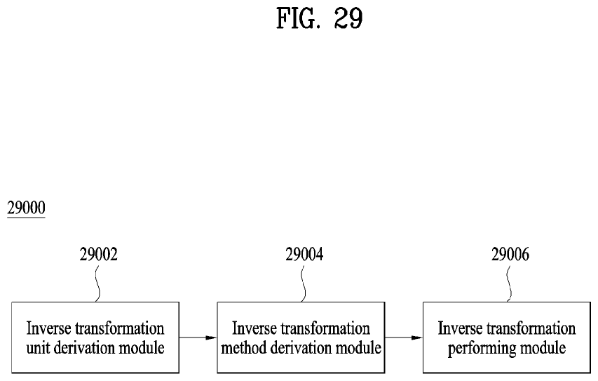

FIG. 29 illustrates an inverse transformation process of the inverse transformation unit and inverse transformation method derivation module 27006 according to embodiments. The inverse transformation unit and inverse transformation method derivation module 27006 may output restoration residual geometry information by performing inverse transformation in units of inverse transformation units.

The inverse transformation unit and inverse transformation method derivation module 27006 according to embodiments includes an inverse transformation unit derivation module 29002, an inverse transformation method derivation module 29004, and an inverse transformation performing module 29006.

The inverse transformation unit derivation module 29002 may parse a method of splitting the current node into inverse transformation subnodes. The inverse transformation unit derivation module 29002 may parse information about whether to perform split into inverse transformation subnodes, and in case of split, and parse information about a split type for splitting the current node into inverse transformation subnodes. At this time, if a split type is a tree structure, split may be performed by parsing the tree type recursively, and if the split type is a lattice split, an inverse transformation subnode may be derived by parsing a split number and a split length for each axis. The inverse transformation unit derivation module 29002 may generate one or more inverse transformation units by reconstructing transformation coefficient values for each axis into a matrix among transformation coefficients included in the inverse transformation subnode. In addition, the inverse transformation unit derivation module 29002 may parse information about a shape of the inverse transformation unit and reconstruct the inverse transformation unit using the parsed information.

The inverse transformation method derivation module 29004 may parse information on the inverse transformation method in units of inverse transformation units. The inverse transformation performing module 29006 may generate restoration residual geometry information for the current node by performing inverse transformation in units of inverse transformation units. In addition, the inverse transformation performing module 29006 may arrange the restoration residual geometry information split into inverse transformation subnode units in the point scan order of the current node.

Hereinafter, a process of generating restoration geometry information in relation to a point cloud data processing method according to embodiments will be described.

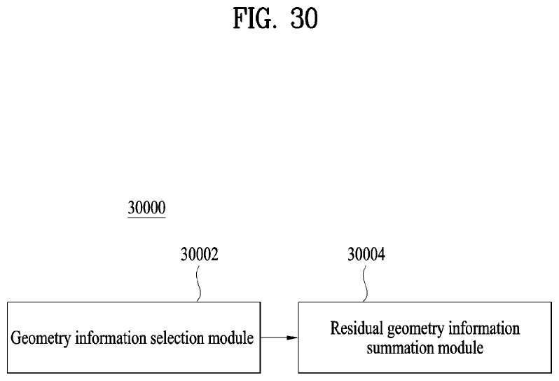

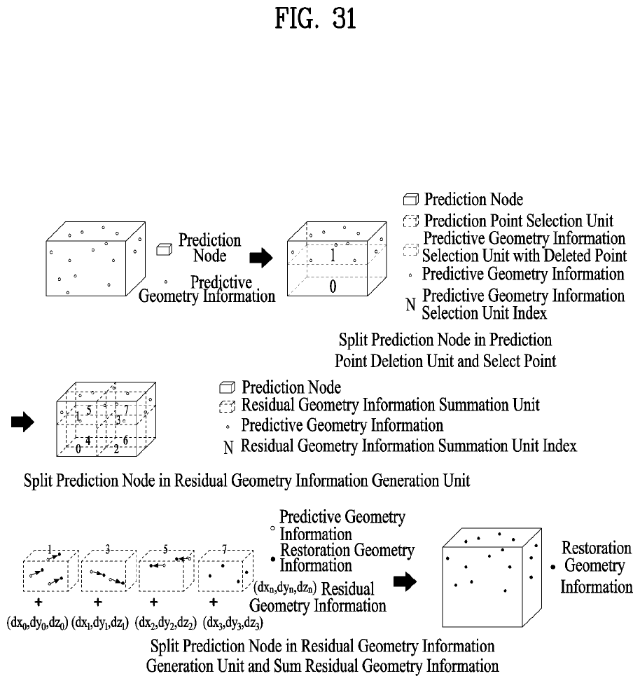

FIGS. 30 and 31 are diagrams to explain a process of generating restoration geometry information according to embodiments.

The restoration geometry information may be generated by adding the restored residual geometry information to the predictive geometry information generated by a predictive geometry information generator (for example, the geometry information intra/inter predictor of FIGS. 36 and 38). Generation of restoration geometry information according to embodiments may be performed by operations of the geometry information selection module 30002 and the residual geometry information summation module 30004, and the order of each component may be changed or omitted.

The geometry information selection module 30002 may select and delete one or more geometry information in a prediction node. The geometry information selection module 30002 may split the prediction node into a geometry information selection unit (or prediction point selection unit) and delete predictive geometry information in a geometry information selection unit. The geometry information selection module 30002 may parse information about a method of splitting a geometry information selection unit. The geometry information selection module 30002 may parse information about the shape of a geometry information selection unit according to a split method. A shape of the geometry information selection unit may be n×m×1, where n, m, and 1 may each have a value of 1 or more. The geometry information selection module 30002 may recursively parse tree-type information when the split type of the geometry information selection unit split method is a tree structure, and when the split type is a lattice split, the geometry information selection module 30002 may parse information on the number of splits and the split length for each axis to derive a geometry information selection unit. The geometry information selection module 30002 may parse the number and index information of geometry information selection units from which predictive geometry information (or prediction points) is to be deleted. That is, the geometry information screening module 30002 may parse information about deletion of predictive geometry information. Also, the geometry information selection module 30002 may delete predictive geometry information based on a subprediction node of a prediction node. Since the subprediction node is assigned an index, predictive geometry information may be deleted in units of subprediction nodes based on the parsed index.

The residual geometry information summing module 30004 may generate restoration geometry information by adding residual geometry information to predictive geometry information. The residual geometry information summing module 30004 may split the prediction node into residual geometry information summing units and parse the split type. The size of the residual geometry information summation unit may be n×m×1, where n, m, and 1 may each be a value of 1 or more. The residual geometry information summation module 30004 may parse information about the size of the residual geometry information summation unit or split of the residual geometry information summation unit, and may perform split based on the parsed information. If the split type is a tree structure, the tree type information may be parsed recursively, and if the split type is a lattice split, the residual geometry information summation unit may be derived by parsing the number of splits and the split length information for each axis.

As shown in FIG. 31, restoration geometry information may be output by summing the same residual geometry information values for all points in one residual geometry information summing unit. The residual geometry information may be output from the inverse transformation performing module 29006 and may be composed of residual values of the x, y, and z axes.

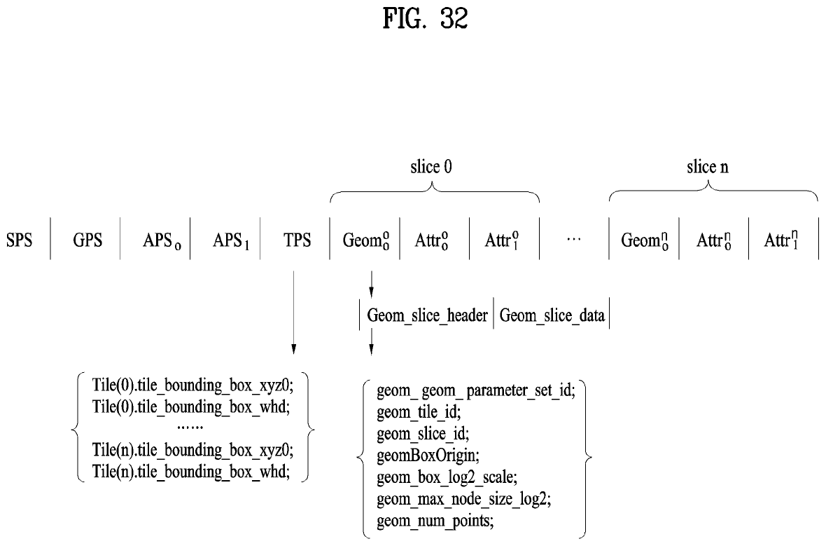

FIG. 32 shows an example of encoded point cloud data (bitstream) according to embodiments. The bitstream may include encoded geometry information (geometry), encoded attribute information (attribute), and parameter information, and may be generated in the point cloud data transmission device according to the embodiments (e.g., the point cloud encoder or transmission device described in FIGS. 1, 4, 12, 15, 36, and 37). The point cloud data transmission device according to the embodiments may transfer information related to generation of residual geometry information, quantization and inverse quantization, transformation and inverse transformation processes, etc. described in FIGS. 1 to 31 to the point cloud data reception device according to the embodiments in a bitstream.

Referring to FIG. 32, all or part of information on parameters according to embodiments may be defined in a sequence parameter set, and each information may be defined in a tile parameter set, and a separate geometry node parameter set may be defined to operate dependently or independently of the existing structure. Depending on an application or a system, an application range and method may be configured differently by being defined at a corresponding location or a separate location. In addition, when the defined syntax element is capable of being applied to a plurality of point cloud data streams as well as a point cloud data stream, the related information may be included in a parameter set of a higher concept, etc., and may be transferred to the reception device according to the embodiments.

The point cloud video encoder 10002 according to embodiments may encode point cloud data in an encoding 20001 process, and the transmitter 10003 according to embodiments may transmit a bitstream including the encoded point cloud data to the reception device 10004.

Encoded point cloud data (bitstream) according to the embodiments may be generated by the point cloud video encoder 10002 in FIG. 1, the encoding 20001 in FIG. 2, the encoder in FIG. 4, the transmission device in FIG. 12, the XR device 1430 in FIG. 14, the point cloud encoder in FIG. 15, 36 or 37 and/or hardware, software, firmware, or a combination thereof including one or more processors or integrated circuits configured to communicate with one or more memories.

In addition, the encoded point cloud data (bitstream) according to the embodiments may be decoded by the point cloud video decoder 10006 in FIG. 1, the decoding 20003 in FIG. 2, the decoder in FIG. 11, the reception device in FIG. 13, the XR device 1430 in FIG. 14, the point cloud decoder in FIG. 16, 38 or 39, and/or hardware, software, firmware, or a combination thereof including one or more processors or integrated circuits configured to communicate with one or more memories.

The meanings of the abbreviations shown in FIG. 32 are as follows.

SPS: Sequence Parameter Set

GPS: Geometry Parameter Sets

APS: Attribute Parameter Set

TPS: Tile Parameter Set

Geom: Geometry bitstream=geometry slice header+geometry slice data

Attr: Attribute bitstream=Attribute brick header+attribute brick data

Parameters according to the embodiments (which may be variously called metadata, signaling information, etc.) may be generated in a data processing process of the transmission devices according to the embodiments (FIGS. 1, 4, 12, 14, 15, 36, 37), and may be transferred to the reception device (FIGS. 1, 11, 13, 14, 16, 38, and 39) according to the embodiments to be used in the point cloud data restoration process. For example, parameters according to embodiments may be generated in a metadata processor (or metadata generator) of the transmission device according to embodiments, and obtained in a metadata parser of the reception device according to embodiments.

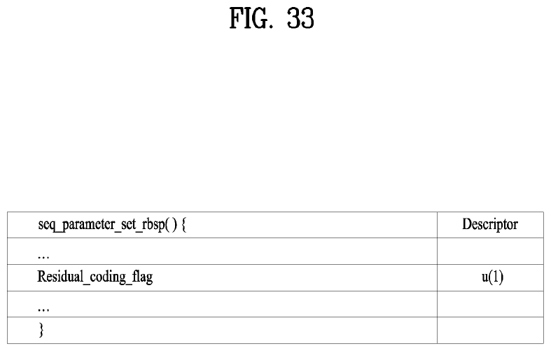

FIG. 33 illustrates an example of syntax of a sequence parameter set according to embodiments. A flag for signaling presence or absence of residual coding may be defined in a sequence parameter set.

When a residual coding flag (Residual_coding_flag) does not transmit simple residual information, but different residual information processing methods are applied according to transformation units, true may be signaled (If the residual_coding_flag is 1, residual coding is performed in a transformation unit, and if the residual_coding_flag is 0, simple residual information is signaled or a best motion vector is signaled.)

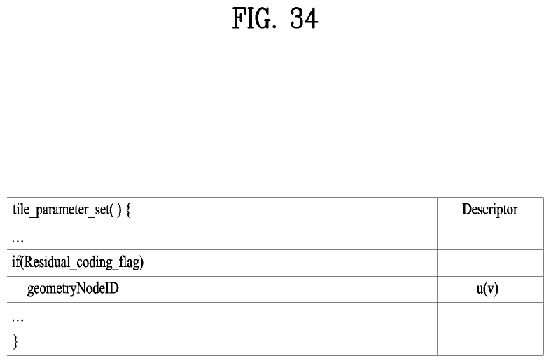

FIG. 34 illustrates an example of a syntax of a tile parameter set according to embodiments. Residual geometry information may be defined and signaled in the tile parameter set.

When the residual coding flag (Residual_coding_flag) of residual geometry information is 1, the geometry node ID may be processed as residual information in units of geometry information nodes, and an ID of the geometry node may be signaled.

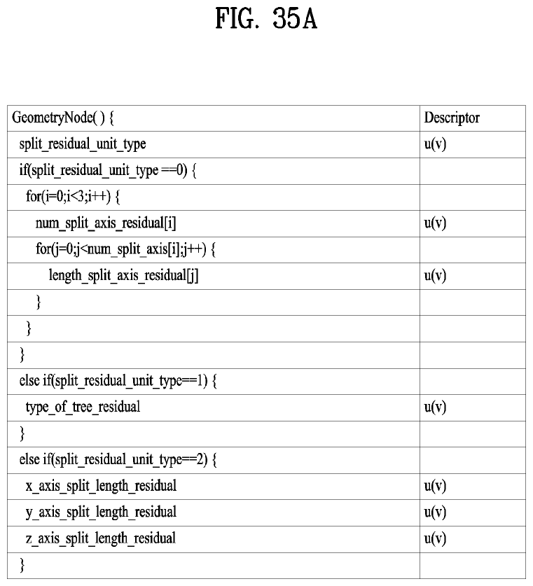

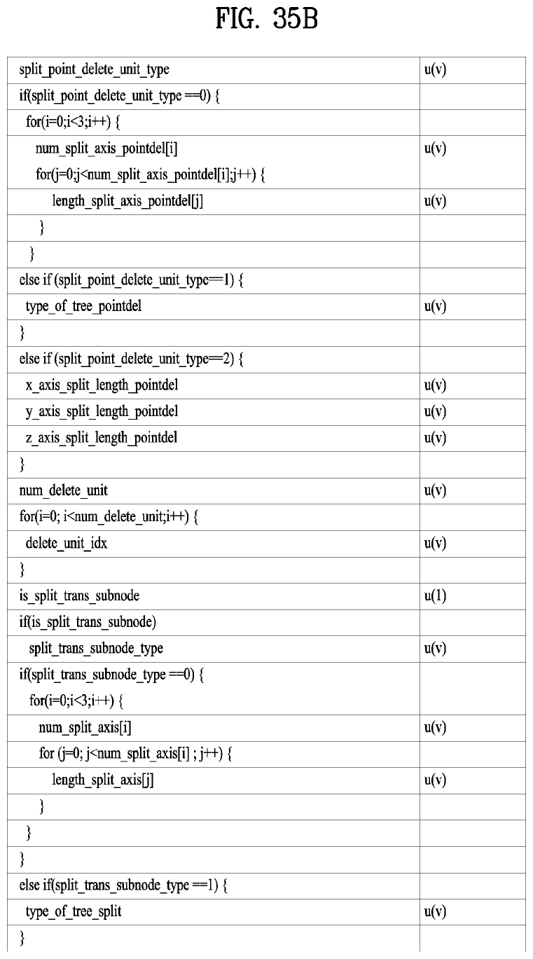

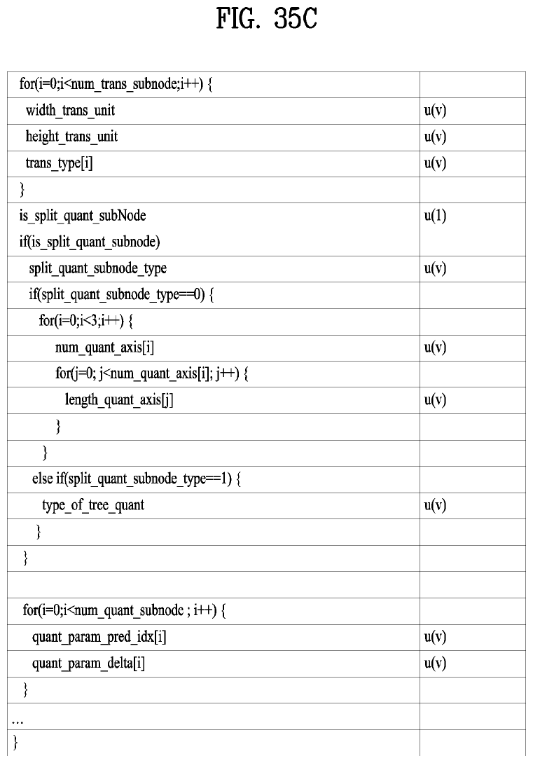

FIGS. 35A to 35C show an example of a syntax of a geometry node according to embodiments. The residual geometry information may be defined and signaled in the geometry node.

The geometry node is a lower level of a geometry parameter set and may be included in a geometry data unit (geometry_data_unit) that refers to the geometry parameter set. The geometry data unit binds the slice header and data to be included therein. That is, the geometry data unit may be understood as a unit including Geom_slice_header and Geom_slice_data of FIG. 32. Syntaxes included in the geometry node may be generated by the residual geometry information generator 17000 of FIG. 17 or the residual geometry information transformation quantizer 36008 of FIG. 36 and transmitted as a bitstream to the reception device according to embodiments.

A split residual unit type (split_residual_unit_type) represents a method for splitting residual geometry information summation units. (0000 may represent a lattice split, 0001 may represent tree split, and 0010 may represent axis split. 0011 to 1111 may be reserved for future use.)

A number split axis residual (num_split_axis_residual [i]) may indicate the number of splits for each axis when the split type is a lattice split.

Length split axis residual (length_split_axis_residual [j]) may indicate a split length for each axis when the split type is a lattice split.

A type of tree residual (type_of_tree_residual) may indicate a type of a split tree when the split type is a tree structure. (0000 may indicate an octree, 0001 may indicate a quad tree, and 0010 may indicate a binary tree. 0011 to 1111 may be reserved for future use.)

X-axis split length residual (x_axis_split_length_residual) represents an x-axis length of the residual geometry information summation unit.

Y-axis split length residual (y_axis_split_length_residual) represents a y-axis length of the residual geometry information summation unit.

Z-axis split length residual (z_axis_split_length_residual) represents a z-axis length of the residual geometry information summation unit.

Split point delete unit type (Split_point_delete_unit_type) indicates the prediction point selection unit split method. (0000 may indicate a lattice split, 0001 may indicate a tree split, and 0010 may indicate axis split. 0011 to 1111 may be reserved for future use.)

A number split axis pointdel (num_split_axis_pointdel[i]) indicates the number of splits for each axis (x-axis, y-axis, and z-axis) when the split type is a lattice split.

A length split axis pointdel (length_split_axis_pointdel [j]) indicates a split length for each axis (x-axis, y-axis, and z-axis) when the split type is a lattice split.

A type of tree pointdel (type_of_tree_pointdel) indicates a split tree type when the split type is a tree structure. (0000 may represent an octree, 0001 may represent a quad tree, and 0010 may represent a binary tree. 0011 to 1111 may be reserved for future use.)

X-axis split length point del (x_axis_split_length_pointdel) represents an x-axis length of a prediction point selection unit (or geometry information selection unit).

Y-axis split length pointdel (y_axis_split_length_pointdel) represents a y-axis length of a prediction point selection unit (or geometry information selection unit).

Z-axis split length pointdel (z_axis_split_length_pointdel) represents a z-axis length of a prediction point selection unit (or geometry information selection unit).

A number delete unit (num_delete_unit) represents the number of prediction point selection units (or geometry information selection units) to be deleted.

A delete unit index (delete_unit_idx) represents an index of a prediction point selection unit (or geometry information selection unit) to be deleted.

Is split trans subnode (is_split_trans_subnode) is a flag indicating whether to split the geometry information node (or current node) into inverse transformation subnodes. When the flag is 0, the geometry information node may not be split, and when the flag is 1, the geometry information node may be split into the inverse transformation subnodes.

A split trans subnode type (split_trans_subnode_type) may indicate a split type when splitting a geometry information node (or current node) into inverse transformation subnodes. 0 indicates a lattice split and 1 indicates tree split. (0000 represents a lattice split, and 0001 represents tree split. 0010 to 1111 may be reserved for future use.)

A number split axis (num_split_axis [i]) may indicate the number of splits for each axis when the split type is a lattice split (split_invtrans_subnode_type==0).

A length split axis (length_split_axis [j]) may indicate split lengths for each axis when the split type is a lattice split (split_invtrans_subnode_type==0).

A type of tree split (type_of_tree_split) may indicate a split tree type when the split type is a tree structure (split_invtrans_subnode_type==1). (0000 may represent an octree, 0001 may represent a quad tree, and 0010 may represent a binary tree. 0011 to 1111 may be reserved for future use.)

A transtype (trans_type[i]) may indicate a transformation type for transformation units in a transformation subnode. (0000 may indicate DCT, 0001 may indicate DST, 0010 may indicate SADCT, and 0011 may indicate RATH transformation. 0100 to 1111 may be omitted for future use.)

A width transformation unit (width_trans_unit) represents a width of a transformation unit when residual information in a transformation subnode is configured as an information unit transformation unit for each axis.

A height transformation unit (height_trans_unit) represents the height of the transformation unit when the residual information in the transformation subnode is configured as an information unit transformation unit for each axis.

Is Split Quant subnode (is_split_quant_subnode) is a flag indicating whether to split the geometry information node (or current node) into quantization subnodes. If the flag is 0, the geometry information node may not be split into quantization subnodes, and if the flag is 1, the geometry information node may be split into quantization subnodes.

Split quant subnode type (split_quant_subnode_type) represents a split type when a geometry information node (or current node) is split into quantization subnodes. If the flag is 0, it may represent a lattice split, and if the flag is 1, it may represent tree split. (0000 represents a lattice split, 0001 represents tree split, and 0010 to 1111 may be reserved for future use.)

A number quant axis (num_quant_axis [i]) indicates the number of splits for each axis when the split type is a lattice split (split_quant_subnode_type==0).

A length quant axis (length_quant_axis [i]) indicates the lengths split for each axis when a split type is a lattice split (split_quant_subnode_type==0).

A type of tree quant (type_of_tree_quant) may indicate a split tree type (0000 may indicate an octree, 0001 may indicate a quad tree, and 0010 may indicate a binary tree) when a split type is a tree structure (split_quant_subnode_type==1). 1111 may be reserved for future use.)

A quant subnode number (num_quant_subnode) indicates the number of quantization subnodes.

A quant parameter prediction index (quant_param_pred_idx[i]) may indicate a prediction quantization parameter index of the quantization subnode.

A parameter delta index (quant_param_delta[i]) may indicate a residual quantization parameter of the quantization subnode.

FIG. 36 illustrates an example of the geometry information encoder 36000 of a point cloud data transmission device according to embodiments. The geometry information encoder 36000 according to embodiments may correspond to the geometry information encoder 15004 of FIG. 15.

The geometry information encoder 36000 according to embodiments may include a coordinate system transformer 36002, a geometry information transformation quantizer 36004, a geometry information coding method deriver 36006, a residual geometry information transformation quantizer 36008, a geometry information entropy encoder 36010, a residual geometry information inverse transformation inverse quantizer 36012, a memory 36020, a geometry information intra predictor 36024, the geometry information inter predictor 36022, a geometry information inverse transformation inverse quantizer 36016, or a coordinate system inverse transformer 36018.

A geometry information splitter (not shown) may split geometry information of point cloud data into a slice, a tile, a brick, a subframe, etc. The point cloud data may be input to the coordinate system transformer 36002 in units of frames or split geometry information.

The coordinate system transformer 36002 may receive geometry information as an input and transform the geometry information into a coordinate system different from the existing coordinate system. Alternatively, coordinate system transformation may not be performed. Geometry information transformed to the coordinate system may be input to the geometry information transformation quantizer 36004. Whether to transform a coordinate system and coordinate system information may be signaled in units such as sequences, frames, tiles, slices, blocks, etc., or may be derived using information on whether or not a coordinate system of neighboring blocks is transformed, a block size, a number of points, a quantization value, a block division depth, a unit position, and a distance between the unit and the origin. If coordinate system transformation is performed after checking whether or not coordinate system transformation is performed, coordinate system information may be signaled in units such as sequences, frames, tiles, slices, blocks, etc. or may be derived using information on whether or not a coordinate system of neighboring blocks is transformed, a block size, a number of points, a quantization value, a block division depth, a unit position, and a distance between the unit and the origin.

The geometry information transformation quantizer 36004 receives geometry information as an input, applies one or more transformations such as position transformation and/or rotation transformation, and then quantizes the geometry information by dividing the geometry information with quantization values to generate transformed quantized geometry information. The transformed quantized geometry information may be input to the geometry information node splitter.

The geometry information coding method deriver 36006 receives transformed quantized geometry information in units such as frames, slices, and tiles, and derives or determines coding information such as a split mode and a coding mode of geometry information.

The geometry information intra predictor 36024 generates predictive geometry information by predicting geometry information through geometry information in the same frame in which restoration has been previously completed. The prediction information used for prediction may be encoded by performing entropy encoding.

The geometry information inter predictor 36022 generates predictive geometry information by predicting geometry information through geometry information of other restored frames stored in memory. The prediction information used for prediction may be encoded by performing entropy encoding.

A residual geometry information transformation quantizer receives geometry information and predicted geometry information as calm geometry residual information and performs transformation or quantization with a quantization value to generate quantized residual geometry information. The quantized residual geometry information may be input to the geometry information entropy encoder and the residual geometry information inverse quantizer.

The geometry information entropy encoder 36010 may perform entropy encoding by receiving quantized geometry residual information, predictive geometry information, etc. Entropy coding may use various coding methods such as Exponential Golomb, Context-Adaptive Variable Length Coding (CAVLC), or Context-Adaptive Binary Arithmetic Coding (CABAC).

The residual geometry information inverse transformation inverse quantizer 36012 receives quantized residual geometry information and scales the information to a quantization value or performs inverse transformation to restore residual geometry information. The restored residual geometry information may be combined with predictive geometry information to restore geometry information and may be stored in the memory 36020.

The geometry information inverse transformation inverse quantizer 36016 may generate restoration geometry information in which inverse quantization is performed by multiplying restoration geometry information by the quantization value executed by the geometry information transformation quantizer. The geometry information inverse transformation inverse quantizer 36016 may be operated before storing in the memory 36020 or after storing in the memory 36020.

The coordinate system inverse transformer 36018 may inverse transform a coordinate system of restoration geometry information to a coordinate system before transformation in the coordinate system transformer 36002.

A filtering unit 36014 may perform filtering on restored geometry information. The filtering unit 36014 may include a deblocking filter, an offset corrector, an ALF, and the like.

The memory 36020 may store geometry information calculated through the filtering unit 36014 or prior to filtering. The stored geometry information may be transferred to the geometry information inter predictor 36022 or the geometry information intra predictor 36024 when prediction is performed.

FIG. 37 illustrates an example of the attribute information encoder 37000 of a point cloud data transmission device according to embodiments. The attribute information encoder 37000 according to embodiments may correspond to the attribute information encoder 15006 of FIG. 15.

The attribute information encoder 37000 according to embodiments may include an attribute information transformer 37002, a geometry information mapper 37004, an attribute information node splitter 37006, a residual attribute information transformation quantizer 37008, an attribute information entropy encoder 37010, a residual attribute information inverse transformation inverse quantizer 37012, a filtering unit 37016, a memory 37018, an attribute information intra predictor 37022, or an attribute information inter predictor 37020.

The attribute information transformer 37002 may transform a color space of attribute information if the input attribute information represents the color space. The transformed attribute information may be input to the geometry information mapper 37004. The attribute information transformer 37002 may transmit the color space of attribute information as it is to the geometry information mapper 37004 without transforming the attribute information.

The geometry information mapper 37004 reconstructs the attribute information by mapping the attribute information received from the attribute information transformer 37002 and the received restored geometry information. Reconstruction of the attribute information may derive attribute values based on attribute information of one or more points based on restored geometry information. The reconstructed attribute information may be input to the residual attribute information transformation quantizer 37008 after being differentiated from the predicted attribute information generated in the attribute information predictor (attribute information intra predictor or attribute information inter predictor).

The attribute information node splitter 37006 may divide the attribute information received from the geometry information mapper 37004 into nodes.

The residual attribute information transformation quantizer 37008 may transform residual 3D blocks including received residual attribute information using transformation types such as DCT, DST, DST, SADCT or RAHT. The residual attribute information may be input to the residual attribute information quantizer after transformation or input to the residual attribute information quantizer without transformation. Information on the transformation type may be transmitted to a decoder according to embodiments by performing entropy encoding in an entropy encoder. The transformed residual attribute information may be quantized based on a quantization value to generate transformed quantized residual attribute information. The quantized residual attribute information may be input to the attribute information entropy encoder 37010 and the residual attribute information inverse transformation inverse quantizer 37012.

The attribute information entropy encoder 37010 may perform entropy encoding by receiving the transformed quantized attribute residual information. Entropy encoding may use various encoding methods such as Exponential Golomb, Context-Adaptive Variable Length Coding (CAVLC), or Context-Adaptive Binary Arithmetic Coding (CABAC).

The residual attribute information inverse transformation inverse quantizer 37012 receives the transformed quantized residual attribute information and performs inverse quantization based on the quantization value to generate transformed residual attribute information. The generated transformation residual attribute information may be input to the residual attribute inverse transformer. The residual attribute inverse transformer may inverse transform the residual 3D block including the received transformation residual attribute information using transformation types such as DCT, DST, DST, SADCT, and RAHT. Residual attribute information subjected to inverse transformation may be added to predicted attribute information input from an attribute information predictor to generate restored attribute information. Alternatively, restored attribute information may be generated by combining residual attribute information with predicted attribute information without inverse transformation.

The filtering unit 37016 may include a deblocking filter, an offset corrector, an Adaptive Loop Filter (ALF), and the like. The filtering unit 37016 may perform filtering on restored attribute information.

The attribute information inverse transformer 37014 may perform inverse transformation of various color spaces such as RGB-YUV and RGB-YUV by receiving a type of attribute information and transformation information from the entropy decoder.

The memory 37018 may store attribute information calculated through the filtering unit 37016. The stored attribute information may be provided to an attribute information predictor (attribute information inter/intra predictor) when performing prediction.

The attribute information intra predictor 37022 and the attribute information inter predictor 37020 may generate prediction attribute information based on attribute information of points of the memory 37018. The attribute information intra predictor 37022 and the attribute information inter predictor 37020 may use attribute information or geometry information of points of the same frame or different frames stored in the memory 37018. Prediction information may be encoded by performing entropy encoding.

FIG. 38 illustrates an example of a geometry information decoder 38000 of a point cloud data reception device according to embodiments. The geometry information decoder 38000 according to embodiments may correspond to the geometry information decoder 16004 of FIG. 16.

The geometry information decoder 38000 may include a geometry information entropy decoder 38002, a geometry information coding method deriver 38004, the residual geometry information inverse transformation inverse quantizer 38006, a geometry information predictor (geometry information intra/inter predictor), or a coordinate system inverse transformer 38012.

The geometry information entropy decoder 38002 may perform entropy decoding on an input bitstream. Various methods such as Exponential Golomb, Context-Adaptive Variable Length Coding (CAVLC), or Context-Adaptive Binary Arithmetic Coding (CABAC) may be used to perform entropy decoding. In addition, the geometry information entropy decoder 38002 may decode information related to geometry information prediction performed by the encoder. Quantized residual geometry information generated through entropy decoding may be input to the geometry residual information inverse transformation inverse quantizer 38006.

The geometry information coding method deriver 38004 may derive a coding method such as a coding mode and a split mode of geometry information, and depending on the coding method, whether to execute a residual geometry information restorer (or residual geometry information inverse transformation inverse quantizer), a geometry information intra predictor 38018, and a geometry information inter predictor 38016 and an execution method thereof may be derived.

The residual geometry information inverse transformation inverse quantizer 38006 may receive quantized residual geometry information and scale the information to a quantization value or may perform inverse transformation to restore residual geometry information. The restored residual geometry information may be restored as geometry information in addition to predictive geometry information and may be stored in a memory.

The geometry information inter predictor 38016 and the geometry information intra predictor 38018 may generate predictive geometry information based on predictive geometry information generation related information provided from the geometry information entropy decoder 38002 and decoded geometry information provided from a memory 38014. The geometry information inter predictor 38016 may perform inter prediction for the current prediction unit based on information included in at least one space before or after the current space including the current prediction unit using information necessary for inter prediction of the current prediction unit transmitted from the encoder. The geometry information intra predictor 38018 may generate predictive geometry information based on geometry information of points in the current space. When the prediction unit performs intra prediction, intra prediction may be performed based on intra prediction mode information of the prediction unit transmitted from the encoder. The restoration geometry information may be generated by adding restoration residual geometry information to predictive geometry information.

The restoration geometry information may be provided to the filtering unit 38008. A filtering unit 38008 may perform filtering based on filtering-related information provided from the decoder or the characteristics of restoration geometry information derived from the decoder.

A geometry information inverse transformation inverse quantizer 38010 may perform inverse transformation or inverse quantization on filtered or unfiltered restoration geometry information.

The coordinate system inverse transformer 38012 may perform coordinate system inverse transformation based on coordinate system transformation related information provided by the geometry information entropy decoder 38002 and restored geometry information stored in the memory 38014.

The memory 38014 may store output geometry information of the filtering unit 38008, the geometry information inverse transformation inverse quantizer 38010 or the coordinate system inverse transformer 38012.

FIG. 39 illustrates an example of the attribute information decoder 39000 of a point cloud data reception device according to embodiments. The attribute information decoder 39000 according to embodiments may correspond to the attribute information decoder 16006 of FIG. 16.

The attribute information decoder 39000 may include an attribute information entropy decoder 39002, a geometry information mapper 39004, a residual attribute information inverse transformation inverse quantizer 39008, an attribute information intra predictor 39018, an attribute information inter predictor 39016, an attribute information filtering unit 39012, a memory 39014, or an attribute information inverse transformer 39010.

The attribute information entropy decoder 39002 may entropy-decode the input attribute information bitstream to generate transformed quantized attribute information. The transformed quantized attribute information is input to the geometry information mapper 39004.

The geometry information mapper 39004 maps transformed quantized attribute information and restored geometry information received from the attribute information entropy decoder 39002. The attribute information mapped to geometry information may be input to the residual attribute information inverse transformation inverse quantizer 39008.

An attribute information node division information deriver 39006 may perform an operation of parsing or deriving split information of a unit that performs prediction, transformation, or quantization of attribute information. The splitting information may mean a splitting type such as octree, quad tree, and binary tree.

The residual attribute information inverse transformation inverse quantizer 39008 performs inverse quantization on the received transformed quantized residual attribute information based on the quantization value and performs inverse transformation to generate restored residual attribute information. The residual attribute information inverse transformation inverse quantizer 39008 may inverse transform a residual 3D block including the received transformed residual attribute information using a transformation type such as DCT, DST, DST, SADCT or RAHT. The inverse transformed residual attribute information may be added to the predicted attribute information generated from the attribute information predictor and stored in the memory 39014. Alternatively, the residual attribute information may be added to the predicted attribute information and stored in the memory 39014 without inverse transformation.

The attribute information intra predictor 39018 and the attribute information inter predictor 39016 generate prediction attribute information based on the attribute information of points stored in the memory 39014. The attribute information intra predictor 39018 and the attribute information inter predictor 39016 may use attribute information or geometry information of points of the same frame or different frames stored in the memory 39014. Prediction information may be encoded by performing entropy encoding.

The attribute information inverse transformer 39010 may receive a type of attribute information and transformation information from the attribute information entropy decoder 39002, and perform inverse transformation of various color spaces such as RGB-YUV and RGB-YUV.

The attribute information filtering unit 39012 may include a deblocking filter, an offset corrector, an adaptive Loop Filter (ALF), and the like. The filtering unit 39012 may perform filtering on restored attribute information.

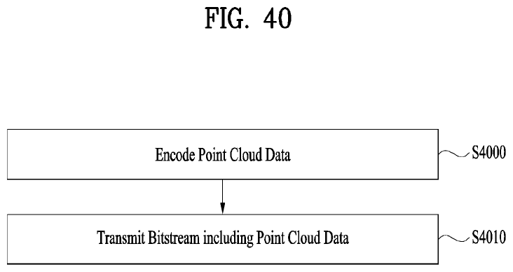

FIG. 40 illustrates an example of a method of transmitting point cloud data according to embodiments. Referring to FIG. 40, the method may include encoding point cloud data (S4000) and transmitting a bitstream including the point cloud data (S4010). The encoding the point cloud data (S4000) may include encoding geometry information of the point cloud data and encoding attribute information of the point cloud data.

The encoding the point cloud data (S4000) may be an operation of encoding point cloud data by the point cloud video encoder 10002 in FIG. 1, the encoding 20001 in FIG. 2, the encoder in FIG. 4, the transmission device in FIG. 12, the XR device 1430 in FIG. 14, the encoder of FIGS. 15, 36, and 37, and/or hardware, software, firmware, or a combination thereof including one or more processors or integrated circuits configured to communicate with one or more memories.

The transmitting the bitstream including point cloud data (S4010) may be an operation of transmitting the point cloud data by the transmitter 10003 of FIG. 1, the transmission processor 12012 of FIG. 12, the XR device 1430 of FIG. 14, the encoder of FIGS. 15, 37, and 38, and/or hardware, software, firmware, or a combination thereof including one or more processors or integrated circuits configured to communicate with one or more memories.

The encoding the point cloud data (S4000) includes encoding geometry information and encoding attribute information. The encoding the geometry information may encode geometry information based on octree, prediction tree, or tree order, and the encoding the attribute information may encode the attribute information based on prediction/lifting transformation or RATH transformation.

The encoding the geometry information according to embodiments may further include generating residual geometry information based on original geometry information and predictive geometry information. The residual geometry information may be generated by differentiating original geometry information and predictive geometry information or by performing a bit operation. Alternatively, residual geometry information may be generated by other methods. The predictive geometry information includes geometry information predicted by an inter predictor or an intra predictor according to embodiments.

The generating the residual geometry information may further include selecting predictive geometry information by deleting at least one of the predictive geometry information and generating residual geometry information based on the original geometry information and the selected predictive geometry information.

The selecting predictive geometry information may be an operation of selecting predictive geometry information based on a distance between original geometry information and predictive geometry information. The selecting the predictive geometry information may be performed by deleting the corresponding predictive geometry information when the distance between the original geometry information and the predictive geometry information is greater than a certain threshold value. Also, the selecting the predictive geometry information may be performed based on representative geometry information of original geometry information or representative geometry information of predictive geometry information. In addition, the selecting the predictive geometry information may be performed for each geometry information selection unit.

The residual geometry information may include residual occupancy. The residual occupancy may be derived by differentiating or performing bitwise operation on the original occupancy generated based on original geometry information and the predicted occupancy generated based on predictive geometry information.

The selecting the predictive geometry information and the generating the residual geometry information may be performed by the residual geometry information generator 17000 of FIG. 17. Specifically, the selecting the predictive geometry information may be performed in the geometry information selection module 17002 of FIG. 17, and the generating the residual geometry information may be performed in the geometry information difference module 17004 of FIG. 17. Details of each operation have been described in the description of FIGS. 17 to 20.

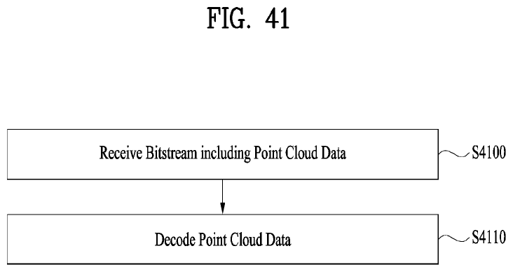

FIG. 41 illustrates an example of a method for receiving point cloud data according to embodiments. Referring to FIG. 41, the method may include receiving a bitstream including point cloud data (S4100) and decoding the point cloud data (S4110). The decoding the point cloud data (S4110) includes decoding geometry information of the point cloud data and decoding attribute information of the point cloud data.

The receiving the bitstream including point cloud data (S4100) includes receiving the point cloud data by the reception device 10004 of FIG. 1, the reception device of FIGS. 10 and 11, the receiver 13000 of FIG. 13, the XR device 1430 of FIG. 14, the decoder of FIGS. 16, 38, and 39, and/or hardware, software, firmware, or a combination thereof including one or more processors or integrated circuits configured to communicate with one or more memories.

The decoding the point cloud data (S3310) includes decoding the point cloud data by the point cloud video decoder 10006 in FIG. 1, the reception device in FIGS. 10, 11, and 13, the XR device 1430 in FIG. 14, the decoder in FIGS. 16, 38, and 39, and/or hardware, software, firmware, or a combination thereof including one or more processors or integrated circuits configured to communicate with one or more memories.

In the receiving the bitstream including point cloud data (S4100), the bitstream includes residual geometry information. The decoding the point cloud data (S3310) includes generating and selecting predictive geometry information and adding the selected predictive geometry information and residual geometry information.

In the generating and selecting the predictive geometry information, the predictive geometry information may be generated by the geometry information predictor (inter predictor or intra predictor) of FIG. 36 or 38. The selecting the predictive geometry information may be performed by a geometry information selection module 30002 of FIG. 30. At this time, the operation of the geometry information selection module 30002 may correspond to the geometry information selection module 170002 of FIG. 17.

The bitstream includes information on deletion of predictive geometry information, and the geometry information selection module 30002 may select predictive geometry information by deleting predictive geometry information based on information on deletion of predictive geometry information.

In the adding the residual geometry information, residual geometry information received as a bitstream and predictive geometry information selected by the geometry information selection module 30002 may be added. The residual geometry information summation may be performed by the residual geometry information summation module 30004 of FIG. 30. The residual geometry information summation module 30004 may restore geometry information based on the residual geometry information summation unit by summing the selected predictive geometry information and the residual geometry information. The restoration of geometry information has been described with reference to FIG. 30.

The bitstream may include residual occupancy information. In this case, the decoding the geometry information of the point cloud data may include generating predicted occupancy information and adding the predicted occupancy information and the residual occupancy information. The predictive occupancy information may be derived based on predictive geometry information generated by the geometry information predictor (inter predictor or intra predictor) of FIG. 36 or 38. Occupancy information may be restored by calculating the derived predicted occupancy information with the residual occupancy information included in the bitstream. In the decoding of geometry information, occupancy information may be restored based on prediction occupancy and residual occupancy according to a bit operation method of prediction occupancy and original occupancy performed by the encoder. The residual occupancy information according to embodiments has been described in FIG. 20.

The point cloud data transmission/reception device or transmission/reception method according to embodiments relates to a residual geometry information processing method for efficient data management such as a reference frame/slice/prediction unit during inter prediction, and relates to a method of processing residual information by splitting and selecting points to be decoded into residual geometry information, and applying, quantizing, and restoring transformation methods by classifying residual geometry information units. At this time, the residual information of the restored cloud point may be decoded or encoded via transformation into sub-transformation units, and the efficiency and accuracy of coding may be increased through the residual information processing. The point cloud data transmission/reception device or transmission/reception method according to the embodiments may perform transformation and quantization of point cloud data, and generation and summation of residual geometry information in an optimal unit by defining a quantization unit, a transformation unit, a residual geometry information generation unit, and a residual geometry information summing unit, and increase the encoding/decoding efficiency of the point cloud data. The operation process may be more advantageous than performing various operations for a certain unit regardless of the characteristics of operations performed in each step.

The method/device for transmitting point cloud data according to embodiments may efficiently encode and transmit point cloud data based on processing of residual geometry information, and the method/device for receiving point cloud data according to embodiments may efficiently and accurately restore the point cloud data based on processing of the point cloud data.

Embodiments have been described from the method and/or device perspective, and descriptions of methods and devices may be applied so as to complement each other.

Although the accompanying drawings have been described separately for simplicity, it is possible to design new embodiments by merging the embodiments illustrated in the respective drawings. Designing a recording medium readable by a computer on which programs for executing the above-described embodiments are recorded as needed by those skilled in the art also falls within the scope of the appended claims and their equivalents. The devices and methods according to embodiments may not be limited by the configurations and methods of the embodiments described above. Various modifications may be made to the embodiments by selectively combining all or some of the embodiments. Although preferred embodiments have been described with reference to the drawings, those skilled in the art will appreciate that various modifications and variations may be made in the embodiments without departing from the spirit or scope of the disclosure described in the appended claims. Such modifications are not to be understood individually from the technical idea or perspective of the embodiments.

Various elements of the devices of the embodiments may be implemented by hardware, software, firmware, or a combination thereof. Various elements in the embodiments may be implemented by a single chip, for example, a single hardware circuit. According to embodiments, the components according to the embodiments may be implemented as separate chips, respectively. According to embodiments, at least one or more of the components of the device according to the embodiments may include one or more processors capable of executing one or more programs. The one or more programs may perform any one or more of the operations/methods according to the embodiments or include instructions for performing the same.

Executable instructions for performing the method/operations of the device according to the embodiments may be stored in a non-transitory CRM or other computer program products configured to be executed by one or more processors, or may be stored in a transitory CRM or other computer program products configured to be executed by one or more processors.

In addition, the memory according to the embodiments may be used as a concept covering not only volatile memories (e.g., RAM) but also nonvolatile memories, flash memories, and PROMs. In addition, it may also be implemented in the form of a carrier wave, such as transmission over the Internet. In addition, the processor-readable recording medium may be distributed to computer systems connected over a network such that the processor-readable code may be stored and executed in a distributed fashion.

In this specification, the term “/“and”,” should be interpreted as indicating “and/or.” For instance, the expression “A/B” may mean “A and/or B.” Further, “A, B” may mean “A and/or B.” Further, “A/B/C” may mean “at least one of A, B, and/or C.” Also, “A/B/C” may mean “at least one of A, B, and/or C.” Further, in this specification, the term “or” should be interpreted as indicating “and/or.” For instance, the expression “A or B” may mean 1) only A, 2) only B, or 3) both A and B. In other words, the term “or” used in this document should be interpreted as indicating “additionally or alternatively.”

Terms such as first and second may be used to describe various elements of the embodiments. However, various components according to the embodiments should not be limited by the above terms. These terms are only used to distinguish one element from another. For example, a first user input signal may be referred to as a second user input signal. Similarly, the second user input signal may be referred to as a first user input signal. Use of these terms should be construed as not departing from the scope of the various embodiments. The first user input signal and the second user input signal are both user input signals, but do not mean the same user input signals unless context clearly dictates otherwise.

The terms used to describe the embodiments are used for the purpose of describing specific embodiments, and are not intended to limit the embodiments. As used in the description of the embodiments and in the claims, the singular forms “a”, “an”, and “the” include plural referents unless the context clearly dictates otherwise. The expression “and/or” is used to include all possible combinations of terms. The terms such as “includes” or “has” are intended to indicate existence of figures, numbers, steps, elements, and/or components and should be understood as not precluding possibility of existence of additional existence of figures, numbers, steps, elements, and/or components. As used herein, conditional expressions such as “if” and “when” are not limited to an optional case and are intended to be interpreted, when a specific condition is satisfied, to perform the related operation or interpret the related definition according to the specific condition.

Operations according to the embodiments described in this specification may be performed by a transmission/reception device including a memory and/or a processor according to embodiments. The memory may store programs for processing/controlling the operations according to the embodiments, and the processor may control various operations described in this specification. The processor may be referred to as a controller or the like. In embodiments, operations may be performed by firmware, software, and/or a combination thereof. The firmware, software, and/or a combination thereof may be stored in the processor or the memory.

The operations according to the above-described embodiments may be performed by the transmission device and/or the reception device according to the embodiments. The transmission/reception device includes a transmitter/receiver configured to transmit and receive media data, a memory configured to store instructions (program code, algorithms, flowcharts and/or data) for a process according to embodiments, and a processor configured to control operations of the transmission/reception device.

The processor may be referred to as a controller or the like, and may correspond to, for example, hardware, software, and/or a combination thereof. The operations according to the above-described embodiments may be performed by the processor. In addition, the processor may be implemented as an encoder/decoder for the operations of the above-described embodiments.

As described above, related contents have been described in the best mode for carrying out the embodiments.

As described above, the embodiments may be fully or partially applied to the point cloud data transmission/reception device and system. It will be apparent to those skilled in the art that various changes or modifications may be made to the embodiments within the scope of the embodiments. Thus, it is intended that the embodiments cover the modifications and variations of this disclosure provided they come within the scope of the appended claims and their equivalents.

What is claimed is:

1. A method of transmitting point cloud data, the method comprising:
encoding point cloud data;
transmitting a bitstream including the point cloud data,
wherein the encoding the point cloud data includes:
encoding geometry information of the point cloud data; and
encoding attribute information of the point cloud data.

2. The method of claim 1, wherein the encoding the geometry information of the point cloud data further includes generating residual geometry information based on original geometry information and predictive geometry information.

3. The method of claim 2, wherein the generating the residual geometry information includes:
selecting the predictive geometry information by deleting at least one of the predictive geometry information; and
generating residual geometry information based on the original geometry information and the selected predictive geometry information.

4. The method of claim 3, wherein the selecting the predictive geometry information includes selecting the predictive geometry information based on a distance between the original geometry information and the predictive geometry information.

5. The method of claim 4, wherein the generating the residual geometry information includes generating residual geometry information based on a distance between representative geometry information of the original geometry information and the predictive geometry information.

6. The method of claim 2, wherein the generating the residual geometry information includes;
generating predicted occupancy based on the predictive geometry information and generating original occupancy based on the original geometry information; and
generating residual occupancy based on the original occupancy and the predicted occupancy.

7. A point cloud data transmission device comprising:
an encoder configured to encode point cloud data; and
a transmitter configured to transmit a bitstream including the point cloud data,
wherein the encoder includes a geometry information encoder configured to encode geometry information of the point cloud data, and an attribute information encoder configured to encode attribute information of the point cloud data.

8. The point cloud data transmission device of claim 7, wherein the geometry information encoder includes a residual geometry information generator configured to generate residual geometry information based on original geometry information and predictive geometry information.

9. The point cloud data transmission device of claim 8, wherein the residual geometry information generator includes:
a geometry information selection module configured to select the predictive geometry information by deleting at least one of the predictive geometry information; and
a geometry information difference module configured to generate residual geometry information based on the original geometry information and the selected predictive geometry information.

10. The point cloud data transmission device of claim 9, wherein the geometry information selection module selects the predictive geometry information based on a distance between the original geometry information and the predictive geometry information.

11. The point cloud data transmission device of claim 8, wherein the geometry information difference module generates residual geometry information based on a distance between representative geometry information of the original geometry information and the predictive geometry information.

12. The point cloud data transmission device of claim 8, wherein the residual geometry information generator generates predicted occupancy based on the predictive geometry information, generates original occupancy based on the original geometry information, and generates residual occupancy based on the original occupancy and the predicted occupancy.

13. A method of receiving point cloud data, the method comprising:
receiving a bitstream including point cloud data; and
decoding the point cloud data,
wherein the decoding the point cloud data includes:
decoding geometry information of the point cloud data; and
decoding attribute information of the point cloud data.

14. The method of claim 13, wherein the bitstream includes residual geometry information; and
wherein the decoding the geometry information of the point cloud data includes:
generating and selecting predictive geometry information; and
summing the selected predictive geometry information and the residual geometry information.

15. The method of claim 14, wherein the bitstream includes information on deleted predictive geometry information; and
wherein the generating and selecting the predictive geometry information includes selecting the predictive geometry information by deleting at least one of the predictive geometry information based on the information on the deleted predictive geometry information.

16. The method of claim 15, wherein the summing includes restoring geometry information by summing the selected predictive geometry information and the residual geometry information based on a residual geometry information summation unit.

17. The method of claim 13, wherein the bitstream includes residual occupancy information; and
wherein the decoding the geometry information of the point cloud data includes:
generating predicted occupancy information; and
calculating the predicted occupancy information and the residual occupancy information.

18. A point cloud data reception device comprising:
a receiver configured to receive a bitstream including point cloud data; and
a decoder configured to decode the point cloud data,
wherein the decoder includes:
a geometry information decoder configured to decode geometry information of the point cloud data; and
an attribute information decoder configured to decode attribute information of the point cloud data.

19. The point cloud data reception device of claim 18, wherein the bitstream includes residual geometry information; and
wherein the geometry information decoder includes:
a geometry information predictor configured to generate predictive geometry information;
a geometry information selection module configured to select the predictive geometry information; and
a residual geometry information summation module configured to sum the selected predictive geometry information and the residual geometry information.

20. The point cloud data reception device of claim 19, wherein the bitstream includes information on deleted predictive geometry information; and
wherein the geometry information selection module selects the predictive geometry information by deleting at least one of the predictive geometry information based on the information on the deleted predictive geometry information.

21. The point cloud data reception device of claim 20, wherein the residual geometry information summation module restores geometry information by summing the selected predictive geometry information and the residual geometry information based on a residual geometry information summation unit.

22. The point cloud data reception device of claim 18, wherein the bitstream includes residual occupancy information; and
wherein the geometry information decoder generates predictive geometry information, generates predicted occupancy information based on the predictive geometry information, and calculates the predicted occupancy information and the residual occupancy information.
